(19) United States
(12) Patent Application Publication
(10) Pub. No.: US 2012/0280954 A1
(43) Pub. Date: Nov. 8, 2012

(54) PLASMA DISPLAY PANEL DRIVING METHOD AND PLASMA DISPLAY DEVICE

(76) Inventors: Naoyuki Tomioka, Osaka (JP); Takahiko Origuchi, Osaka (JP); Hidehiko Shoji, Osaka (JP)

(21) Appl. No.: 13/520,696

(22) PCT Filed: Jan. 19, 2011
(86) PCT No.: PCT/JP2011/000238

§ 371 Date: Jul. 5, 2012

(30) Foreign Application Priority Data
Jan. 19, 2010 (JP) 2010-008757

(51) Int. Cl. G09G 5/00; G09G 3/28

(52) U.S. Cl. 345/204; 345/60

(57) ABSTRACT

Stable address discharge is caused even in a plasma display panel where the definition is enhanced and the screen is enlarged. For this purpose, in a driving method of a plasma display panel, the image display region of the panel is divided into a plurality of partial display regions each of which includes a plurality of consecutively arranged scan electrodes. In each partial display region, a sequential address operation of sequentially applying scan pulses to the scan electrodes based on the arranging sequence of the scan electrodes on the panel is performed in the address period. To the scan electrode to which a scan pulse is to be firstly applied in the address period, a scan pulse of which the pulse width is set longer than that of the scan pulse to be applied to the other scan electrodes is applied.

### TECHNICAL FIELD

The present invention relates to a driving method of a plasma display panel used in a wall-mounted television or a large monitor, and a plasma display apparatus employing the driving method.

### BACKGROUND ART

An alternating-current surface discharge type panel typical as a plasma display panel (hereinafter referred to as “panel”) has many discharge cells between a front substrate and a rear substrate that are faced to each other. The front substrate has the following elements:
a plurality of display electrode pairs disposed in parallel on a front glass substrate; and
a dielectric layer and protective layer disposed so as to cover the display electrode pairs.
   Here, each display electrode pair is formed of a pair of scan electrode and sustain electrode.

The rear substrate has the following elements:
a plurality of data electrodes disposed in parallel on a rear glass substrate;
a dielectric layer disposed so as to cover the data electrodes;
a plurality of barrier ribs disposed on the dielectric layer in parallel with the data electrodes; and
phosphor layers disposed on the surface of the dielectric layer and on side surfaces of the barrier ribs.

The front substrate and rear substrate are faced to each other so that the display electrode pairs and the data electrodes three-dimensionally intersect, and are sealed. Discharge gas containing xenon with a partial pressure of 5%, for example, is filled into a discharge space in the sealed product. Discharge cells are disposed in the intersecting parts of the display electrode pairs and the data electrodes. In the panel having this structure, ultraviolet rays are emitted by gas discharge in each discharge cell. The ultraviolet rays excite respective phosphors of red (R), green (G), and blue (B) to emit light, and thus provide color image display.

A subfield method is generally used as a method of driving the panel. In this subfield method, one field is divided into a plurality of subfields, and light is emitted or light is not emitted in each discharge cell in each subfield, thereby performing gradation display. Each subfield has an initializing period, an address period, and a sustain period.

In the initializing period, an initializing waveform is applied to each scan electrode, and initializing discharge is caused in each discharge cell. Thus, wall charge required for a subsequent address operation is produced in each discharge cell, and a priming particle (an excitation particle for causing address discharge) for stably causing address discharge is generated.

In the address period, a scan pulse is sequentially applied to scan electrodes, and an address pulse is selectively applied to data electrodes based on an image signal to be displayed. Thus, address discharge is caused between the scan electrode and the data electrode of the discharge cell to emit light, thereby producing wall charge in the discharge cell (hereinafter, this operation is collectively referred to as “address”).

In the sustain period, as many sustain pulses as a number determined for each subfield are alternately applied to the display electrode pairs formed of the scan electrodes and the sustain electrodes. Thus, sustain discharge is caused in the discharge cell having undergone address discharge, thereby emitting light in the phosphor layer of this discharge cell (hereinafter, light emission by sustain discharge in a discharge cell is referred to as “lighting”, and no light emission is referred to as “no-lighting”). Thus, light is emitted in each discharge cell at a luminance corresponding to the luminance weight determined for each subfield. Thus, light is emitted at a luminance corresponding to the gradation value of an image signal in each discharge cell of the panel, and an image is displayed in the image display region of the panel.

In order to drive the panel in such a manner, the plasma display apparatus includes a scan electrode driver circuit, sustain electrode driver circuit, and data electrode driver circuit. The plasma display apparatus applies a driving voltage waveform to each electrode to display an image on the panel.

Recently, the definition of the panel has been enhanced and the screen of the panel has been enlarged, and hence the power consumption of the plasma display apparatus has increased. The data electrode driver circuit applies an address pulse corresponding to an image signal to each of data electrodes to cause address discharge in each discharge cell. When the power consumption of the data electrode driver circuit exceeds an allowance (maximum rating) of a circuit element constituting the data electrode driver circuit, the phenomenon can occur where the data electrode driver circuit malfunctions, a normal address operation is not performed, and the image display quality is damaged. In order to prevent this phenomenon, a circuit element of a large allowance is used. However, such a circuit element is relatively expensive, and becomes one of major factors for increasing the cost of the plasma display apparatus.

Therefore, as a method of suppressing the power consumption of the data electrode driver circuit without reducing the image display quality, a method is disclosed where the sequence of the address pulses to be applied to the data electrodes is changed, the charge/discharge current flowing during charge/discharge of the data electrodes is reduced, and the power consumption of the data electrode driver circuit is suppressed (for example, Patent Literature 1).

In order to change the sequence of the address pulses to be applied to the data electrodes, the sequence of the scan pulses to be applied to the scan electrodes is also required to be changed synchronously with the address pulses. In order to achieve the driving method disclosed in Patent Literature 1, for example, a method is practical in which the following operations are switched based on an image signal to be displayed:
an address operation where scan pulses are applied to n scan electrodes sequentially from the first scan electrode to the n-th scan electrode; and
an address operation where firstly scan pulses are sequentially applied to odd-numbered scan electrodes and then scan pulses are sequentially applied to even-numbered scan electrodes.

When an address operation is performed in a discharge cell, occurrence of the address discharge in this discharge cell is affected by whether address discharge has occurred in its adjacent discharge cell. In a panel where the definition is enhanced, the discharge cells are fine, and hence the difference between the influence when address discharge has occurred in the adjacent discharge cell and that when no address discharge has occurred in the adjacent discharge cell is apt to increase.

In a panel where the definition is enhanced and the screen is enlarged, the number of scan electrodes increases and hence the time required for the address period becomes long. When the time from the initializing discharge to the address discharge becomes long, the wall charge required for the address operation decreases and the address discharge is apt to become unstable.

CITATION LIST

### Patent Literature

### PLT 1

Unexamined Japanese Patent Publication No. H11-282398

### SUMMARY OF THE INVENTION

In a driving method of a panel of the present invention, a panel that has a plurality of discharge cells each of which includes a data electrode and a display electrode pair formed of a scan electrode and a sustain electrode is driven while one field is constituted by a plurality of subfields having an address period and a sustain period. The image display region of the panel is divided into a plurality of partial display regions each of which includes a plurality of consecutively arranged scan electrodes. In each of the partial display regions in the address period, a sequential address operation of sequentially applying scan pulses to respective scan electrodes based on the arranging sequence of the scan electrodes on the panel is performed. To the scan electrode to which a scan pulse is to be firstly applied in the address period, a scan pulse of which the pulse width is set longer than that of the scan pulse to be applied to the other scan electrodes is applied.

Thanks to this method, stable address discharge can be caused even in a panel where the definition is enhanced and the screen is enlarged.

In a driving method of a panel of the present invention, in each of the partial display regions, the ratio of the number of discharge cells to be lit to the total number of discharge cells is detected as a partial light-emitting ratio, and the address operation is performed firstly in the partial display region of the highest partial light-emitting ratio. When a scan electrode to which a scan pulse is to be finally applied in one partial display region is not adjacent to a scan electrode to which a scan pulse is to be firstly applied in a partial display region where the address operation is performed next to the one partial display region, the scan pulse where the pulse width is set to be long may be applied to the scan electrode to which the scan pulse is to be firstly applied.

A plasma display apparatus of the present invention has the following elements:
a panel that has a plurality of discharge cells each of which includes a data electrode and a display electrode pair formed of a scan electrode and a sustain electrode; and
a driver circuit for driving the panel while one field is constituted by a plurality of subfields having an address period and a sustain period.
   Then, the driver circuit has a plurality of scan integrated circuits (ICs) for applying scan pulses to a plurality of consecutively arranged scan electrodes, and divides the image display region of the panel into a plurality of partial display regions. Here, each of the partial display regions is constituted by a plurality of scan electrodes connected to the scan ICs. In each of the partial display regions, the ratio of the number of discharge cells to be lit to the total number of discharge cells is detected as a partial light-emitting ratio, and the address operation is performed firstly in the partial display region of the highest partial light-emitting ratio. In each of the partial display regions in the address period, the scan ICs perform a sequential address operation of sequentially applying scan pulses to respective scan electrodes based on the arranging sequence of the scan electrodes on the panel. To the scan electrode to which a scan pulse is to be firstly applied in the address period, the scan ICs apply a scan pulse of whiche the pulse width is set longer than that of the scan pulse to be applied to the other scan electrodes.

Thanks to this configuration, stable address discharge can be caused even in a panel where the definition is enhanced and the screen is enlarged.

### BRIEF DESCRIPTION OF DRAWINGS

FIG. 1 is an exploded perspective view showing a structure of a panel used in a plasma display apparatus in accordance with an exemplary embodiment of the present invention.

FIG. 2 is an electrode array diagram of the panel used in the plasma display apparatus in accordance with the exemplary embodiment of the present invention.

FIG. 3 is a diagram showing a driving voltage waveform to be applied to each electrode of the panel used in the plasma display apparatus in accordance with the exemplary embodiment of the present invention.

FIG. 4 is a diagram showing the presence/absence of an address pulse in a certain subfield.

FIG. 5 is a diagram for calculating an estimated value of power consumption of a data electrode driver circuit when a sequential address operation is performed.

FIG. 6 is a diagram for calculating an estimated value of power consumption of the data electrode driver circuit when the checked pattern of FIG. 4 is displayed on the panel.

FIG. 7 is a characteristic diagram showing the relationship between the sequence of the address operation in partial display regions and the amplitude of a scan pulse required for causing stable address discharge in accordance with the exemplary embodiment of the present invention.

FIG. 8 is a diagram showing the relationship between the partial light-emitting ratio and the amplitude of a scan pulse required for causing stable address discharge in accordance with the exemplary embodiment of the present invention.

FIG. 9 is a pattern diagram showing the partial display region of the panel in accordance with the exemplary embodiment of the present invention.

FIG. 10 is a timing chart showing one example of an address operation of the plasma display apparatus in accordance with the exemplary embodiment of the present invention.

FIG. 11 is a characteristic diagram showing the relationship between the pulse width of the scan pulse and the amplitude of an address pulse required for causing stable address discharge.

FIG. 12 is a circuit block diagram of the plasma display apparatus in accordance with the exemplary embodiment of the present invention.

FIG. 13 is a circuit diagram showing a configuration of a scan electrode driver circuit of the plasma display apparatus in accordance with the exemplary embodiment of the present invention.

FIG. 14 is a circuit block diagram showing the details of scan ICs of the plasma display apparatus in accordance with the exemplary embodiment of the present invention.

FIG. 15 is a diagram showing operations of output control sections and switching elements of the scan ICs of the plasma display apparatus in accordance with the exemplary embodiment of the present invention.

FIG. 16 is a diagram showing the interconnection of the scan ICs of the plasma display apparatus in accordance with the exemplary embodiment of the present invention.

FIG. 17 is a timing chart for illustrating the operation of the scan ICs of the plasma display apparatus in accordance with the exemplary embodiment of the present invention.

### DESCRIPTION OF EMBODIMENTS

A plasma display apparatus in accordance with an exemplary embodiment of the present invention will be described hereinafter with reference to the accompanying drawings.

### Exemplary Embodiment

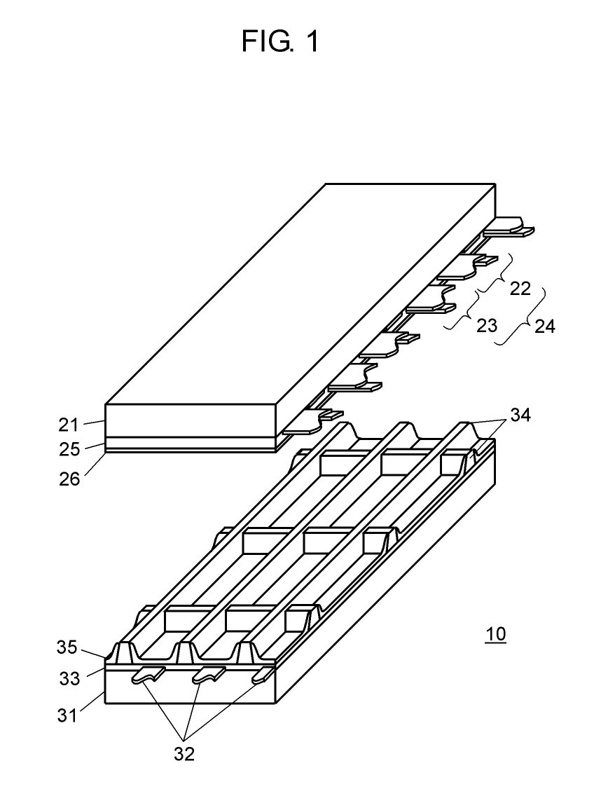

FIG. 1 is an exploded perspective view showing the structure of panel 10 used in a plasma display apparatus in accordance with an exemplary embodiment of the present invention. A plurality of display electrode pairs 24 formed of scan electrodes 22 and sustain electrodes 23 is disposed on glass-made front substrate 21. Dielectric layer 25 is formed so as to cover scan electrodes 22 and sustain electrodes 23, and protective layer 26 is formed on dielectric layer 25. Protective layer 26 is made of a material mainly made of magnesium oxide (MgO).

A plurality of data electrodes 32 is formed on rear substrate 31, dielectric layer 33 is formed so as to cover data electrodes 32, and mesh barrier ribs 34 are formed on dielectric layer 33. Phosphor layers 35 for emitting lights of respective colors of red (R), green (G), and blue (B) are formed on the side surfaces of barrier ribs 34 and on dielectric layer 33.

Front substrate 21 and rear substrate 31 are faced to each other so that display electrode pairs 24 cross data electrodes 32 with a micro discharge space sandwiched between them, and the outer peripheries of them are sealed by a sealing material such as glass frit. The discharge space is filled with mixed gas of neon and xenon as discharge gas, for example.

The discharge space is partitioned into a plurality of sections by barrier ribs 34. Discharge cells are formed in the intersecting parts of display electrode pairs 24 and data electrodes 32. Then, discharge is caused and light is emitted (lighting) in the discharge cells, thereby displaying a color image on panel 10.

In panel 10, one pixel is formed of three consecutive discharge cells arranged in the extending direction of display electrode pairs 24. The three discharge cells are a discharge cell for emitting light of red color (R), a discharge cell for emitting light of green color (G), and a discharge cell for emitting light of blue color (B). Hereinafter, the discharge cell for emitting light of red color is referred to as an R discharge cell, the discharge cell for emitting light of green color is referred to as a G discharge cell, and the discharge cell for emitting light of blue color is referred to as a B discharge cell.

The structure of panel 10 is not limited to the above-mentioned one, but may be a structure having striped barrier ribs, for example. As the mixing percentage of discharge gas, the xenon partial pressure may be set at about 10% in order to improve the luminous efficiency. However, the mixing percentage is not limited to the above-mentioned values, but may be another value.

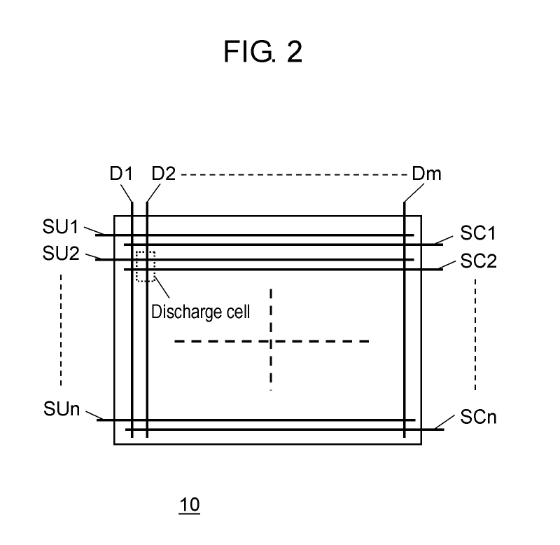

FIG. 2 is an electrode array diagram of panel 10 used in the plasma display apparatus in accordance with the exemplary embodiment of the present invention. Panel 10 has n scan electrode SC1 through scan electrode SCn (scan electrodes 22 in FIG. 1) and n sustain electrode SU1 through sustain electrode SUn (sustain electrodes 23 in FIG. 1) both extended in the row direction (line direction), and m data electrode D1 through data electrode Dm (data electrodes 32 in FIG. 1) extended in the column direction. A discharge cell is formed in the part where a pair of scan electrode SCi (i is 1 through n) and sustain electrode SUi intersect with one data electrode Dj (j is 1 through m). In other words, on one display electrode pair 24, m discharge cells are formed and m/3 pixels are formed. Thus, m×n discharge cells are formed in the discharge space, the region having m×n discharge cells defines the image display region of panel 10. In the panel where the number of pixels is 1920×1080, for example, m is 1920×3 and n is 1080. The n is 768 in the present exemplary embodiment; however, the present invention is not limited to this numerical value.

Next, a driving method of panel 10 of the plasma display apparatus of the present exemplary embodiment is described. The plasma display apparatus of the present exemplary embodiment displays gradations using a subfield method. In this subfield method, the plasma display apparatus divides one field into a plurality of subfields on the time axis, and sets luminance weight for each subfield. Light emission and no light emission of each discharge cell is controlled in each subfield, thereby displaying an image on panel 10.

The luminance weight means the ratio between the luminances displayed in respective subfields, and as many sustain pulses as the number corresponding to the luminance weight are generated in each subfield in the sustain period. Therefore, in the subfield of luminance weight “8”, light is emitted at a luminance about eight times that in the subfield of luminance weight “1”, and light is emitted at a luminance about four times that in the subfield of luminance weight “2”. Therefore, various gradations can be displayed by selectively emitting light in each subfield using a combination corresponding to the image signal, and an image can be displayed.

In the present exemplary embodiment, the following configuration example is described: one field is formed of 8 subfields (first SF, second SF, . . . , eighth SF), and respective subfields have luminance weights of (1, 2, 4, 8, 16, 32, 64, 128) so that the later subfield has a larger luminance weight. In this configuration, an R signal, a G signal, and a B signal can be displayed using 256 gradations, namely 0 through 255.

In the initializing period of one of a plurality of subfields, an all-cell initializing operation of causing initializing discharge in all discharge cells is performed. In the initializing period of the other subfields, a selective initializing operation of selectively causing initializing discharge in a discharge cell having undergone sustain discharge in the sustain period in the immediately preceding subfield is performed. A subfield where the all-cell initializing operation is performed is referred to as “all-cell initializing subfield”. A subfield where the selective initializing operation is performed is referred to as “selective initializing subfield”.

In the present exemplary embodiment, an example is described where the all-cell initializing operation is performed in the initializing period of the first SF and the selective initializing operation is performed in the initializing periods of the second SF through eighth SF. Thus, the light emission related to no image display is only light emission following the discharge of the all-cell initializing operation in the first SF. The luminance of black level, which is luminance in a black displaying region that does not cause sustain discharge, is therefore determined only by weak light emission in the all-cell initializing operation. An image of sharp contrast can be displayed on panel 10.

In the sustain period of each subfield, as many sustain pulses as the number derived by multiplying the luminance weight of each subfield by a predetermined proportionality constant are applied to respective display electrode pairs 24. This proportionality constant is luminance magnification.

In the sustain period, as many sustain pulses as the number derived by multiplying the luminance weight of each subfield by a predetermined luminance magnification are applied to respective display electrodes 22 and sustain electrodes 23. For example, when the luminance magnification is two, four sustain pulses are applied to scan electrodes 22 and four sustain pulses are applied to sustain electrodes 23 in the sustain period of the subfield of luminance weight “2”. Therefore, the number of sustain pulses generated in the sustain period is eight.

In the present exemplary embodiment, however, the number of subfields constituting one field and the luminance weight of each subfield are not limited to the above-mentioned values. The subfield structure may be changed based on the image signal or the like.

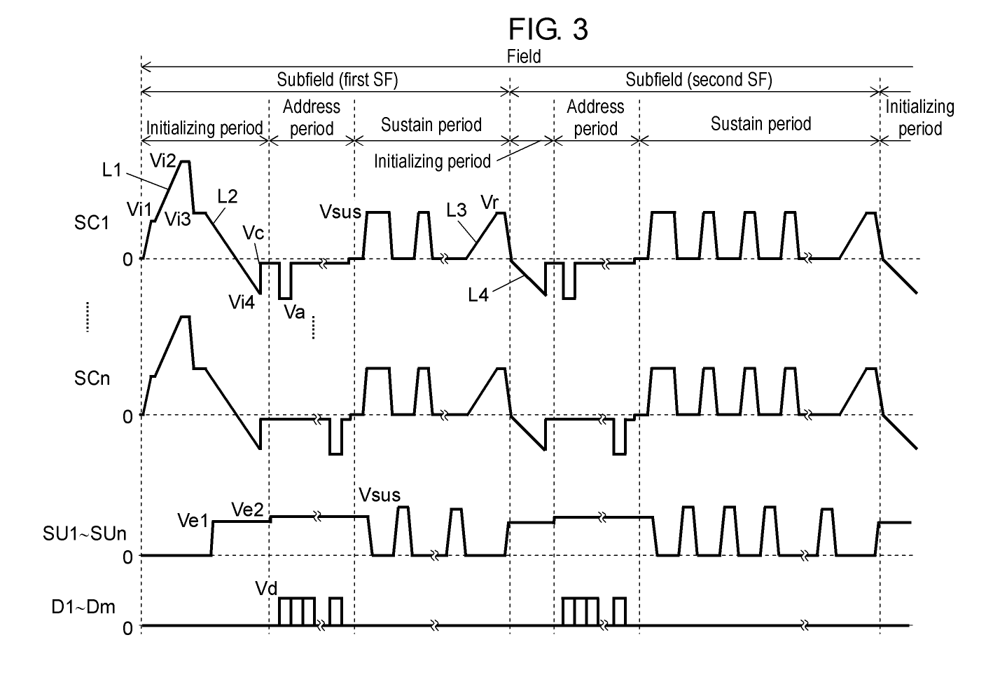

FIG. 3 is a diagram showing a driving voltage waveform to be applied to each electrode of panel 10 used in the plasma display apparatus in accordance with the exemplary embodiment of the present invention. FIG. 3 shows driving voltage waveforms applied to scan electrode SC1 where the address operation is firstly performed in the address period, scan electrode SCn where the address operation is finally performed in the address period, sustain electrode SU1 through sustain electrode SUn, and data electrode D1 through data electrode Dm, respectively.

FIG. 3 shows the driving voltage waveforms of two subfields. These two subfields are a first subfield (first SF) as an all-cell initializing subfield and a second subfield (second SF) as a selective initializing subfield. The driving voltage waveforms in the other subfields are substantially similar to the driving voltage waveform of the second SF except for the number of generated sustain pulses in the sustain period. Scan electrode SCi, sustain electrode SUi, and data electrode Dk described later are electrodes selected from respective types of electrodes based on the image data (indicating lighting and no lighting in each subfield).

First, the first SF as the all-cell initializing subfield is described.

In the first half of the initializing period of the first SF, voltage 0 (V) is applied to data electrode D1 through data electrode Dm and sustain electrode SU1 through sustain electrode SUn. Voltage Vi1 is applied to scan electrode SC1 through scan electrode SCn. Voltage Vi1 is set at the voltage lower than the discharge start voltage with respect to sustain electrode SU1 through sustain electrode SUn. Then, ramp waveform voltage, which gently increases from voltage Vi1 to voltage Vi2, is applied to scan electrode SC1 through scan electrode SCn. Hereinafter, the ramp waveform voltage is referred to as “up-ramp voltage L1”. Voltage Vi2 is set at a voltage exceeding the discharge start voltage with respect to sustain electrode SU1 through sustain electrode SUn. As an example of the gradient of up-ramp voltage L1, a numerical value of about 1.3 V/μsec can be employed.

While up-ramp voltage L1 increases, feeble initializing discharge continuously occurs between scan electrode SC1 through scan electrode SCn and sustain electrode SU1 through sustain electrode SUn, and feeble initializing discharge continuously occurs between scan electrode SC1 through scan electrode SCn and data electrode D1 through data electrode Dm. Then, negative wall voltage is accumulated on scan electrode SC1 through scan electrode SCn, and positive wall voltage is accumulated on data electrode D1 through data electrode Dm and sustain electrode SU1 through sustain electrode SUn. The wall voltage on the electrode means voltage generated by the wall charge accumulated on the dielectric layer for covering the electrodes, the protective layer, or the phosphor layers.

In the latter half of the initializing period, positive voltage Ve1 is applied to sustain electrode SU1 through sustain electrode SUn, and 0 (V) is applied to data electrode D1 through data electrode Dm. Ramp waveform voltage, which gently decreases from voltage Vi3 to negative voltage Vi4, is applied to scan electrode SC1 through scan electrode SCn. Hereinafter, the ramp waveform voltage is referred to as “down-ramp voltage L2”. Voltage Vi3 is set at a voltage lower than the discharge start voltage with respect to sustain electrode SU1 through sustain electrode SUn, and voltage Vi4 is set at a voltage exceeding the discharge start voltage. As an example of the gradient of down-ramp voltage L2, a numerical value of about −2.5 V/μsec can be employed.

While down-ramp voltage L2 is applied to scan electrode SC1 through scan electrode SCn, feeble initializing discharge occurs between scan electrode SC1 through scan electrode SCn and sustain electrode SU1 through sustain electrode SUn, and feeble initializing discharge occurs between scan electrode SC1 through scan electrode SCn and data electrode D1 through data electrode Dm. Then, the negative wall voltage accumulated on scan electrode SC1 through scan electrode SCn and the positive wall voltage accumulated on sustain electrode SU1 through sustain electrode SUn are reduced, and the positive wall voltage accumulated on data electrode D1 through data electrode Dm is adjusted to a value suitable for the address operation. Thus, the all-cell initializing operation of causing the initializing discharge in all discharge cells is completed.

A characteristic operation of the present invention is performed in the subsequent address period, but an outline of the address operation is described. A detailed operation is described later.

In the address period, voltage Ve2 is applied to sustain electrode SU1 through sustain electrode SUn, and voltage Vc is applied to scan electrode SC1 through scan electrode SCn.

Next, a scan pulse of negative voltage Va is applied to scan electrode SCi for firstly performing an address operation, and an address pulse of positive voltage Vd is applied to data electrode Dk corresponding to the discharge cell to emit light in the row for firstly performing an address operation, of data electrode D1 through data electrode Dm. The voltage difference in the intersecting part of data electrode Dk and scan electrode SCi is derived by adding the difference between the wall voltage on data electrode Dk and that on scan electrode SCi to the difference (voltage Vd−voltage Va) of the external applied voltage. Thus, the voltage difference between data electrode Dk and scan electrode SCi exceeds the discharge start voltage, and discharge occurs between data electrode Dk and scan electrode SCi.

Since voltage Ve2 is applied to sustain electrode SU1 through sustain electrode SUn, the voltage difference between sustain electrode SUi and scan electrode SCi is derived by adding the difference between the wall voltage on sustain electrode SUi and that on scan electrode SCi to the difference (voltage Ve2−voltage Va) of the external applied voltage. At this time, by setting voltage Ve2 at a voltage value slightly lower than the discharge start voltage, a state where discharge does not occur but is apt to occur can be caused between sustain electrode SUi and scan electrode SCi.

Therefore, the discharge occurring between data electrode Dk and scan electrode SCi can cause discharge between sustain electrode SUi and scan electrode SCi that exist in a region crossing data electrode Dk. Thus, address discharge occurs in the discharge cell to emit light, positive wall voltage is accumulated on scan electrode SCi, negative wall voltage is accumulated on sustain electrode SUi, and negative wall voltage is also accumulated on data electrode Dk.

The voltage in the part where scan electrode SCi intersects with data electrode 32 to which no address pulse has been applied does not exceed the discharge start voltage, so that address discharge does not occur.

Thus, an address operation is performed in the row for firstly performing the address operation.

Next, a scan pulse is applied to scan electrode SCj for secondly performing an address operation, an address pulse is applied to data electrode Dk corresponding to the discharge cell to emit light in the row for secondly performing the address operation, of data electrode D1 through data electrode Dm. Similarly to the address operation in the first row, address discharge occurs in the discharge cell to which a scan pulse and an address pulse are simultaneously applied. Thus, an address operation is performed in the row for secondly performing the address operation.

These address operations are performed in the discharge cells in all rows, and the address period is completed. Thus, address discharge is caused selectively in a discharge cell to emit light, and wall charge is formed in the discharge cell.

In the subsequent sustain period, 0 (V) is firstly applied to sustain electrode SU1 through sustain electrode SUn, and a sustain pulse of positive voltage Vsus is applied to scan electrode SC1 through scan electrode SCn. In the discharge cell having undergone address discharge, the voltage difference between scan electrode SCi and sustain electrode SUi is obtained by adding the difference between the wall voltage on scan electrode SCi and that on sustain electrode SUi to voltage Vsus of the sustain pulse.

Thus, the voltage difference between scan electrode SCi and sustain electrode SUi exceeds the discharge start voltage, and sustain discharge occurs between scan electrode SCi and sustain electrode SUi. Ultraviolet rays generated by this discharge cause phosphor layer 35 to emit light. By this discharge, negative wall voltage is accumulated on scan electrode SCi, and positive wall voltage is accumulated on sustain electrode SUi. Positive wall voltage is also accumulated on data electrode Dk. In the discharge cell having undergone no address discharge in the address period, sustain discharge does not occur and the wall voltage at the end of the initializing period is kept.

Subsequently, 0 (V) is applied to scan electrode SC1 through scan electrode SCn, and a sustain pulse is applied to sustain electrode SU1 through sustain electrode SUn. In the discharge cell having undergone the sustain discharge, the voltage difference between sustain electrode SUi and scan electrode SCi exceeds the discharge start voltage. Thus, sustain discharge occurs between sustain electrode SUi and scan electrode SCi again, negative wall voltage is accumulated on sustain electrode SUi, and positive wall voltage is accumulated on scan electrode SCi.

Hereinafter, similarly, as many sustain pulses as the number derived by multiplying the luminance weight by a predetermined luminance magnification are alternately applied to scan electrode SC1 through scan electrode SCn and sustain electrode SU1 through sustain electrode SUn. Thus, sustain discharge continuously occurs in the discharge cell having undergone the address discharge in the address period.

After generation of the sustain pulses in the sustain period, in the state where 0 (V) is applied to sustain electrode SU1 through sustain electrode SUn and data electrode D1 through data electrode Dm, ramp waveform voltage, which gently increases from 0 (V) to voltage Vr, is applied to scan electrode SC1 through scan electrode SCn. Hereinafter, the ramp waveform voltage is referred to as “erasing ramp voltage L3”.

The gradient of erasing ramp voltage L3 is set to be steeper than that of up-ramp voltage L1. As an example of the gradient of erasing ramp voltage L3, a numerical value of about 10 V/μsec can be employed. When voltage Vr is set at a voltage exceeding the discharge start voltage, feeble discharge occurs between sustain electrode SUi and scan electrode SCi of the discharge cell having undergone sustain discharge.

Charged particles generated by the feeble discharge are accumulated on sustain electrode SUi and scan electrode SCi so as to reduce the voltage difference between sustain electrode SUi and scan electrode SCi. Therefore, in the discharge cell having undergone sustain discharge, a part or the whole of the wall voltage on scan electrode SCi and sustain electrode SUi is erased while the positive wall voltage is left on data electrode Dk. In other words, the discharge caused by erasing ramp voltage L3 works as “erasing discharge” for erasing unnecessary wall charge accumulated in the discharge cell having undergone sustain discharge.

When the increasing voltage arrives at predetermined voltage Vr, the voltage applied to scan electrode SC1 through scan electrode SCn is decreased to 0 (V) as base potential. Thus, the sustain operation in the sustain period is completed.

In the initializing period of the second SF, the driving voltage waveform where the first half of the initializing period of the first SF is omitted is applied to each electrode. Voltage Ve1 is applied to sustain electrode SU1 through sustain electrode SUn, and 0 (V) is applied to data electrode D1 through data electrode Dm. Down-ramp voltage L4, which decreases from voltage (e.g. 0 (V)) lower than the discharge start voltage to negative voltage Vi4 higher than the discharge start voltage, is applied to scan electrode SC1 through scan electrode SCn. As an example of the gradient of down-ramp voltage L4, a numerical value of about −2.5 V/sec can be employed.

Thus, feeble initializing discharge occurs in the discharge cell having undergone the sustain discharge in the sustain period of the immediately preceding subfield (first SF in FIG. 3). Then, the wall voltages on scan electrode SCi and sustain electrode SUi are reduced, and the wall voltage on data electrode Dk is adjusted to a value suitable for the address operation. In the discharge cell having undergone no sustain discharge in the sustain period of the immediately preceding subfield, initializing discharge does not occur, and the wall charge at the end of the initializing period of the immediately preceding subfield is kept as it is. The initializing operation in the second SF thus becomes the selective initializing operation of causing initializing discharge in the discharge cell that has undergone sustain discharge in the sustain period of the immediately preceding subfield.

In the address period and sustain period of the second SF, driving voltage waveforms similar to those in the address period and sustain period of the first SF are applied to the electrodes except for the number of generated sustain pulses. In each subfield of the third SF and later, a driving voltage waveform similar to that of the second SF is applied to each electrode except for the number of generated sustain pulses.

The driving voltage waveform applied to each electrode of panel 10 of the present exemplary embodiment has been described schematically.

In the present exemplary embodiment, the following voltage values are applied to respective electrodes, for example. Voltage Vi1 is 145 (V), voltage Vi2 is 350 (V), voltage Vi3 is 190 (V), voltage Vi4 is −160 (V), voltage Va is −180 (V), voltage Vsus is 190 (V), voltage Vr is 190 (V), voltage Ve1 is 125 (V), voltage Ve2 is 125 (V), and voltage Vd is 60 (V). Voltage Vc can be generated by adding positive voltage Vscn(=145 (V)) to negative voltage Va(−180 (V)), and in this case voltage Vc is −35 (V). These voltage values are simply one example. Preferably, the voltage values are set at optimal values based on the characteristics of panel 10 and the specification of the plasma display apparatus.

Next, the details of the operation in the address period are described. First, a method of suppressing the power consumption of the data electrode driver circuit without reducing the image display quality is described.

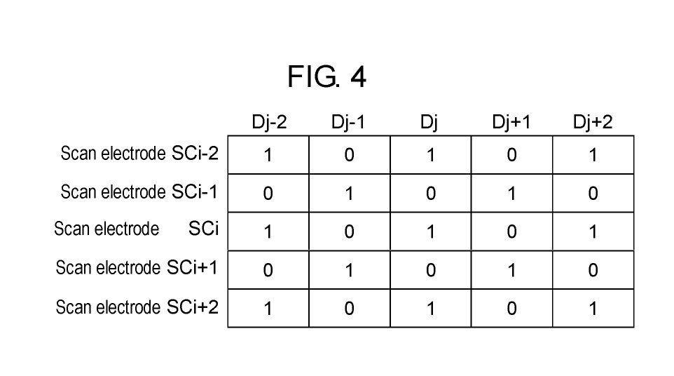

FIG. 4 is a diagram showing the presence/absence of an address pulse in a certain subfield. FIG. 4 shows 5×5=25 discharge cells as an example. The following “i” and “j” are simply convenient signals for illustrating the sequence of the address operation.

In FIG. 4, “0” shows that no address pulse occurs and “1” shows that an address pulse occurs. The generation pattern of the address pulses shown in FIG. 4 is not a special pattern, even a natural picture or the like can be generated by image signal processing such as the so-called dither processing. As shown in FIG. 4, a pattern where address pulses occur alternately in the row direction and column direction is denoted as “checked address pattern”, and the emission pattern of the discharge cells generated by “checked address pattern” is denoted as “checked pattern”. In such a checked address pattern, it is recognized that the power consumption of the data electrode driver circuit significantly depends on the applying sequence of the scan pulses to scan electrodes 22.

Hereinafter, the following address operation is denoted as “sequential address operation”: scan pulses are applied to scan electrode SC1 through scan electrode SCn in the arranging sequence of scan electrode SC1 through scan electrode SCn on panel 10, for example in the sequence of scan electrode SCi−2, scan electrode SCi−1, scan electrode SCi, scan electrode SCi+1, scan electrode SCi+2, etc.

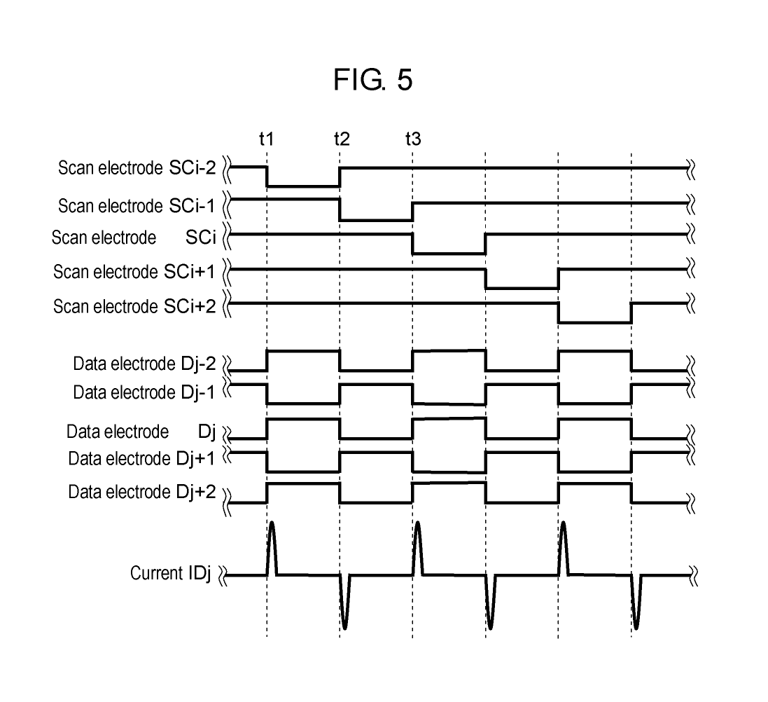

FIG. 5 is a diagram for calculating an estimated value of power consumption of a data electrode driver circuit when a sequential address operation is performed. FIG. 5 shows scan pulses applied to scan electrode SCi−2 through scan electrode SCi+2, address pulses applied to data electrode Dj−2 through data electrode Dj+2, and current waveform IDj flowing in data electrode Dj due to charge/discharge of the inter-electrode capacity.

As shown in FIG. 5, in the period from time t1 to time t2, a scan pulse is applied to scan electrode SCi−2, address pulses are applied to data electrode Dj−2, data electrode Dj, and data electrode Dj+2, and address discharge is caused in the discharge cells where scan electrode SCi−2 intersects with data electrode Dj−2, data electrode Dj, and data electrode Dj+2. No address pulse is applied to data electrode Dj−1 and data electrode Dj+1, and no address discharge is caused in the discharge cells where scan electrode SCi−2 intersects with data electrode Dj−1 and data electrode Dj+1.

In the period from time t2 to time t3, a scan pulse is applied to scan electrode SCi−1, address pulses are applied to data electrode Dj−1 and data electrode Dj+1, and address discharge is caused in the discharge cells where scan electrode SCi−1 intersects with data electrode Dj−1 and data electrode Dj+1. No address pulse is applied to data electrode Dj−2, data electrode Dj, and data electrode Dj+2, and no address discharge is caused in the discharge cells where scan electrode SCi−1 intersects with data electrode Dj−2, data electrode Dj, and data electrode Dj+2.

Hereinafter, similarly, address pulses are alternately applied to data electrode Dj−2, data electrode Dj and data electrode Dj+2, and data electrode Dj−1 and data electrode Dj+1, as shown in FIG. 5.

Current IDj flowing in data electrode Dj at this time, as shown in FIG. 5, flows so that the inter-electrode capacity between data electrode Dj, and scan electrode SC1 through scan electrode SCn and sustain electrode SU1 through sustain electrode SUn is charged or discharged. Therefore, the power consumption of the data electrode driver circuit when a checked pattern is displayed is extremely large.

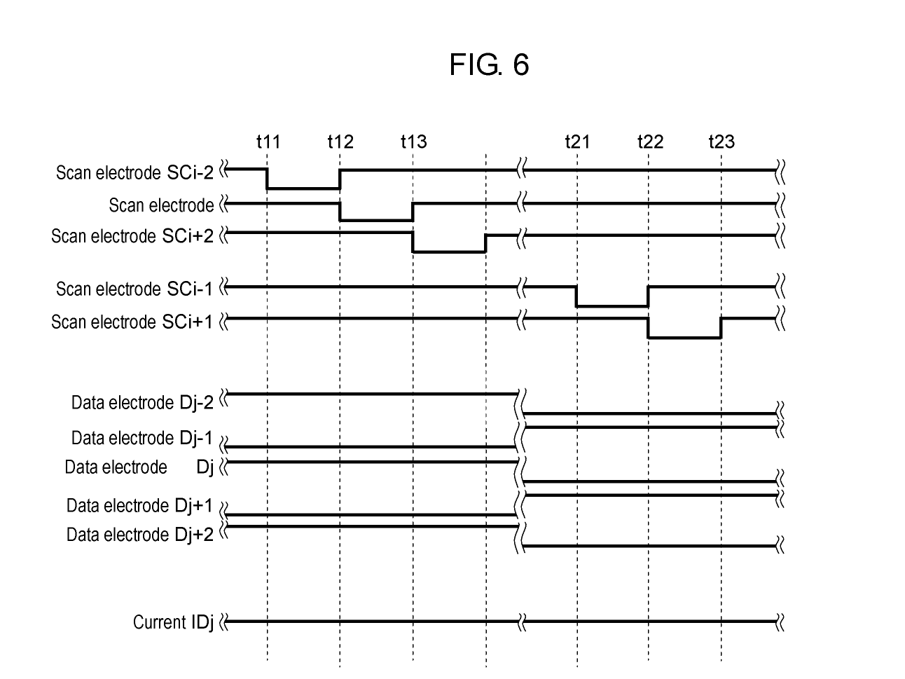

FIG. 6 is a diagram for calculating an estimated value of power consumption of the data electrode driver circuit when the checked pattern of FIG. 4 is displayed. FIG. 6 shows driving voltage waveforms in the address period and the current waveform of charge/discharge of the inter-electrode capacity when “overshoot address operation” is performed. These waveforms are different from the address pattern of FIG. 5. “Overshoot address operation” is an address operation where firstly scan pulses are sequentially applied to odd-numbered scan electrodes 22, of scan electrode SC1 through scan electrode SCn arranged on panel 10, and next scan pulses are sequentially applied to even-numbered scan electrodes 22. In other words, in this address operation, scan pulses are sequentially applied to the scan electrodes in the sequence of scan electrode SCi−2, scan electrode SCi, scan electrode SCi+2, . . . , scan electrode SCi−1, scan electrode SCi+1, etc.

As shown in FIG. 6, in the period from time t11 to time t12, a scan pulse is applied to scan electrode SCi−2, address pulses are applied to data electrode Dj−2, data electrode Dj, and data electrode Dj+2, and address discharge is caused in the discharge cells where scan electrode SCi−2 intersects with data electrode Dj−2, data electrode Dj, and data electrode Dj+2. At this time, no address pulse is applied to data electrode Dj−1 and data electrode Dj+1, and no address discharge is caused in the discharge cells where scan electrode SCi−2 intersects with data electrode Dj−1 and data electrode Dj+1.

In the period from time t12 to time t13, a scan pulse is applied to scan electrode SCi, address pulses are applied to data electrode Dj−2, data electrode Dj, and data electrode Dj+2 similarly to that in the period from time t11 to time t12, and address discharge is caused in the discharge cells where scan electrode SCi intersects with data electrode Dj−2, data electrode Dj, and data electrode Dj+2. No address pulse is applied to data electrode Dj−1 and data electrode Dj+1, and no address discharge is caused in the discharge cells where scan electrode SCi intersects with data electrode Dj−1 and data electrode Dj+1.

Hereinafter, similarly, address pulses are continuously applied to data electrode Dj−2, data electrode Dj, and data electrode Dj+2, and no address pulse is continuously applied to data electrode Dj−1 and data electrode Dj+1.

After the address operation to odd-numbered scan electrodes 22 is completed, the address operation to even-numbered scan electrodes 22 is performed.

In other words, in the period from time t21 to time t22, a scan pulse is applied to scan electrode SCi−1, address pulses are applied to data electrode Dj−1 and data electrode Dj+1, and address discharge is caused in the discharge cells where scan electrode SCi−1 intersects with data electrode Dj−1 and data electrode Dj+1. No address pulse is applied to data electrode Dj−2, data electrode Dj, and data electrode Dj+2, and no address discharge is caused in the discharge cells where scan electrode SCi−1 intersects with data electrode Dj−2, data electrode Dj, and data electrode Dj+2.

In the period from time t22 to time t23, a scan pulse is applied to scan electrode SCi+1, address pulses are applied to data electrode Dj−1 and data electrode Dj+1 similarly to that in the period from time t21 to time t22, and address discharge is caused in the discharge cells where scan electrode SCi+1 intersects with data electrode Dj−1 and data electrode Dj+1. No address pulse is applied to data electrode Dj−2, data electrode Dj, and data electrode Dj+2, and no address discharge is caused in the discharge cells where scan electrode SCi+1 intersects with data electrode Dj−2, data electrode Dj, and data electrode Dj+2.

Hereinafter, similarly, address pulses are continuously applied to data electrode Dj−1 and data electrode Dj+1, and no address pulse is continuously applied to data electrode Dj−2, data electrode Dj, and data electrode Dj+2.

In such an address pattern, no charge/discharge current flows in data electrode Dj, and current IDj becomes 0. Therefore, the power consumption decreases.

Thus, even when images having the same pattern are displayed, the power consumption of the data electrode driver circuit significantly depends on the applying sequence of the scan pulses to scan electrode SC1 through scan electrode SCn.

Therefore, an estimated value of power consumption when a sequential address operation is performed and an estimated value of power consumption when an overshoot address operation is performed are calculated for each subfield. By performing the address operation of lower power, the power consumption of the data electrode driver circuit can be suppressed without reducing the image display quality.

Next, a method of suppressing reduction in the wall charge required for the address operation and performing stable address discharge is described. The inventors, regarding scan electrodes 22 arranged on panel 10, set the region where 64 scan electrodes 22 are consecutively arranged as one partial display region, divide the image display region of panel 10 into 12 partial display regions, and perform the following measurement.

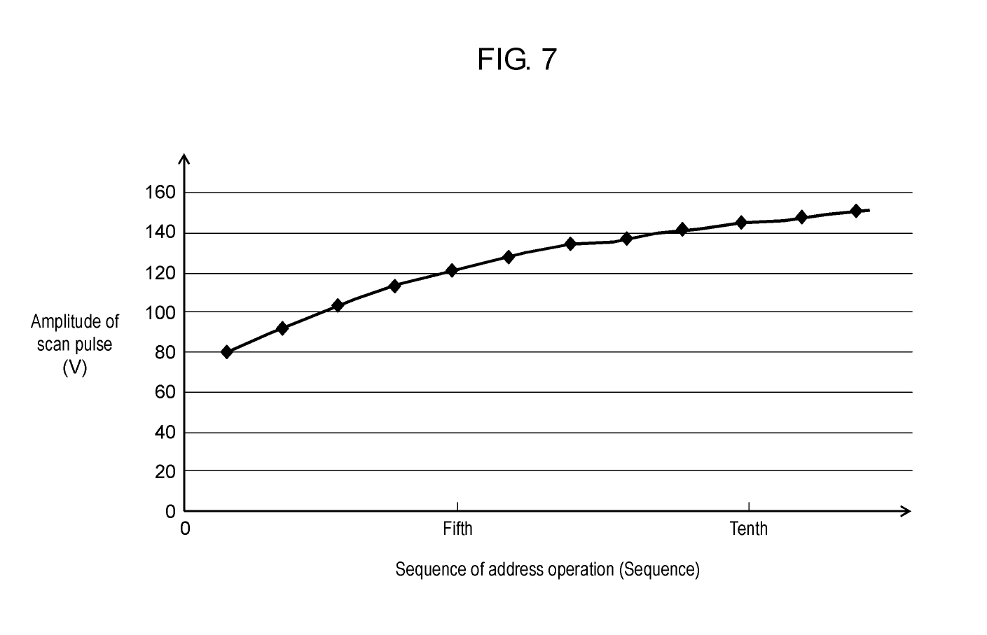

FIG. 7 is a characteristic diagram showing the relationship between the sequence of the address operation in partial display regions and the amplitude of a scan pulse required for causing stable address discharge in accordance with the exemplary embodiment of the present invention. In FIG. 7, the horizontal axis shows the sequence of the address operation in the partial display regions, and the vertical axis shows the amplitude of the scan pulse required for causing stable address discharge.

As shown in FIG. 7, the amplitude of the scan pulse required for causing stable address discharge varies in response to the sequence of the address operation in the partial display regions. In the partial display region where the address operation is performed later in the sequence, the amplitude of the scan pulse required for causing stable address discharge is larger. For example, in the partial display region where the address operation is performed firstly, the amplitude of the scan pulse required for causing stable address discharge is about 80 (V). In the partial display region where the address operation is performed for a 12th time, the amplitude of the required scan pulse is about 150 (V), which is about 70 (V) larger than the former value.

This phenomenon is considered to be caused because the wall charge produced in the initializing period gradually decreases with the passage of time. An address pulse is applied to each data electrode in response to the display image in the address period, so that an address pulse is applied also to a discharge cell to which no scan pulse has been applied. The wall charge thus decreases due to voltage variation caused in a discharge cell. Therefore, it is considered that the wall charge further decreases in a discharge cell where address is performed in the end of the address period.

Hereinafter, the light-emitting ratio of a partial display region (the ratio of the number of discharge cells to be lit to the total number of discharge cells in the region) is denoted as “partial light-emitting ratio”.

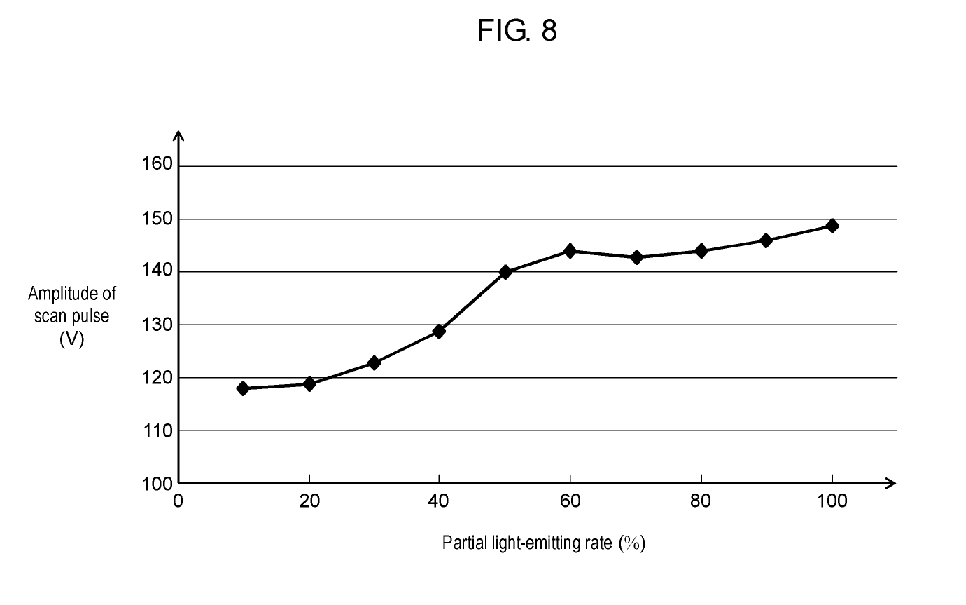

FIG. 8 is a diagram showing the relationship between the partial light-emitting ratio and the amplitude of a scan pulse required for causing stable address discharge in accordance with the exemplary embodiment of the present invention. In FIG. 8, the horizontal axis shows the partial light-emitting ratio, and the vertical axis shows the amplitude of the scan pulse required for causing stable address discharge. The measurement result of FIG. 8 is obtained by measuring the variation of the amplitude of the scan pulse required for causing stable address discharge while varying the ratio of the lit cells in one partial display region.

As shown in FIG. 8, the amplitude of the scan pulse required for causing stable address discharge varies in response to the magnitude of the partial light-emitting ratio. As the partial light-emitting ratio increases, the amplitude of the scan pulse required for causing stable address discharge also increases. For example, when the partial light-emitting ratio is 10%, the amplitude of the scan pulse required for causing stable address discharge is about 118 (V). When the partial light-emitting ratio is 100%, however, the amplitude of the scan pulse required for causing stable address discharge is about 149 (V), which is about 31(V) larger than that when the partial light-emitting ratio is 10%.

This phenomenon is considered to be caused because the discharge current increases and the voltage drop caused in the scan pulse increases when the partial light-emitting ratio increases. This trend is further increased by enhancement of the definition of the panel and by enlargement of the screen thereof.

Thus, the amplitude of the scan pulse required for causing stable address discharge increases as the address operation is performed later in the sequence. The amplitude also increases as the partial light-emitting ratio increases. Therefore, in the partial display region where the address operation is performed later and the partial light-emitting ratio is higher, the amplitude of the scan pulse required for causing stable address discharge further increases.

In other words, these experiment results show that, when the address operation is performed firstly in the partial display region of the highest partial light-emitting ratio, the address operation can be performed stably while the amplitude of the scan pulse required for causing stable address discharge is suppressed.

In the present exemplary embodiment, the image display region of panel 10 is divided into a plurality of partial display regions each of which includes a plurality of consecutively arranged scan electrodes 22 (e.g. 64 scan electrodes 22), and the partial light-emitting ratio is detected in each partial display region. Then, in the address period of the subfield where the partial light-emitting ratio is detected, the address operation is performed by applying the scan pulse firstly in the partial display region of the highest partial light-emitting ratio. An estimated value of power consumption when the sequential address operation is performed and an estimated value of power consumption when the overshoot address operation is performed are calculated. In each partial display region, one of the sequential address operation and the overshoot address operation is selected so as to decrease the power consumption. Thus, the suppression of the power consumption of the data electrode driver circuit is reconciled with stable address discharge.

The number of scan electrodes 22 is simply one example in a partial display region. The number is set optimally in response to the characteristics of panel 10 and the specification of the plasma display apparatus. For example, the number may be the number of scan electrodes 22 connected to one of scan electrode driver ICs for driving scan electrodes 22. The numbers of scan electrodes 22 included in respective partial display regions are not required to be the same, but may be different from each other.

Next, the details of the address operation in the present exemplary embodiment are described while an example is taken.

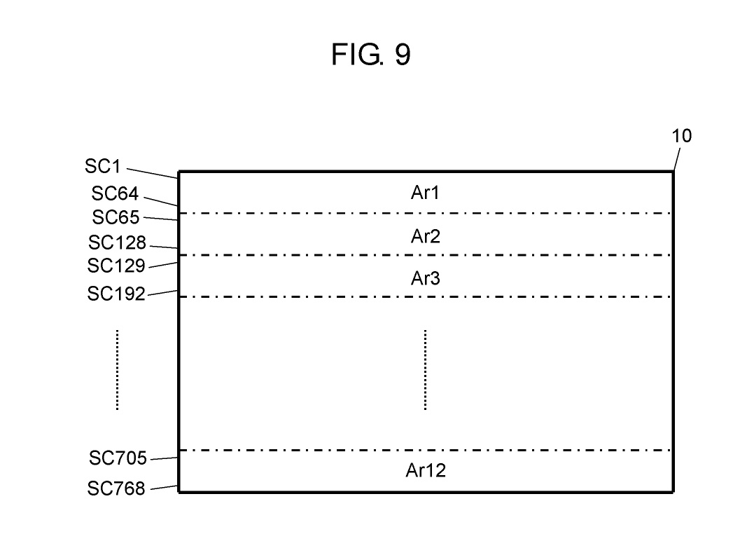

FIG. 9 is a pattern diagram showing the partial display region of panel 10 in accordance with the exemplary embodiment of the present invention. In the present exemplary embodiment, the image display region of panel 10 is divided into 12 partial display region Ar1 through partial display region Ar12. Each of partial display region Ar1 through partial display region Ar12 includes 64 consecutively arranged scan electrodes 22. In other words, partial display region Ar1 includes scan electrode SC1 through scan electrode SC64, partial display region Ar2 includes scan electrode SC65 through scan electrode SC128, partial display region Ar3 includes scan electrode SC129 through scan electrode SC192, subsequently, each partial display region includes 64 scan electrodes 22, and partial display region Ar12 includes scan electrode SC705 through scan electrode SC768.

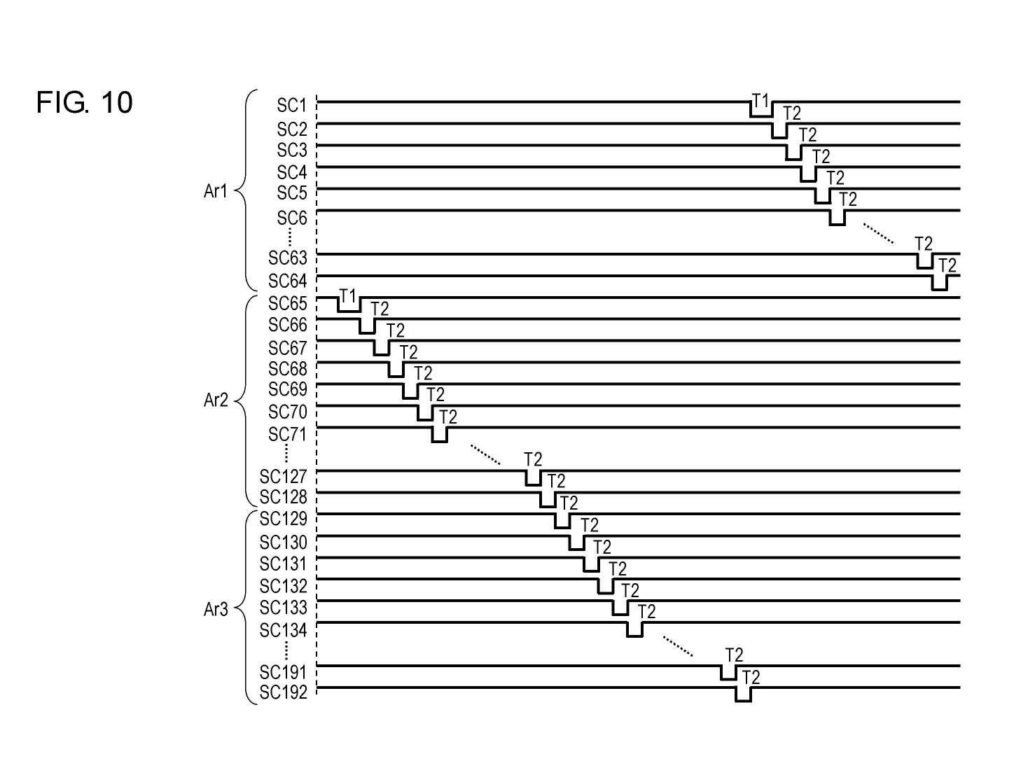

FIG. 10 is a timing chart showing one example of an address operation of the plasma display apparatus in accordance with the exemplary embodiment of the present invention. FIG. 10 shows an example where the partial light-emitting ratio of partial display region Ar2 is the highest, that of partial display region Ar3 is the second highest, and that of partial display region Ar1 is the third highest. In FIG. 10, the address operation is performed firstly in partial display region Ar2, secondly in partial display region Ar3, and thirdly in partial display region Ar1. In FIG. 10, the sequential address operation is performed in partial display region Ar1, partial display region Ar2, and partial display region Ar3.

First, the address operation is performed in partial display region Art of the highest partial light-emitting ratio. In partial display region Ar2, a scan pulse is firstly applied to scan electrode SC65, which is the first scan electrode of scan electrode SC65 through scan electrode SC128 included in partial display region Ar2. The pulse width of the scan pulse is time T1. Next, a scan pulse is applied to second scan electrode SC66. The pulse width of the scan pulse at this time is time T2 shorter than time T1. Subsequently, a scan pulse is applied to each scan electrode 22 in the arranging sequence of scan electrodes 22 on panel 10, for example, in the sequence of scan electrode SC67, scan electrode SC68, scan electrode SC69, . . . , and scan electrode SC128. The pulse width of these scan pulses is also time T2.

The pulse width of the scan pulse means the time from the falling to the rising of the scan pulse.

Next, an address operation is performed in partial display region Ar3 of the second-highest partial light-emitting ratio. In partial display region Ar3, a scan pulse of a pulse width of time T2 is firstly applied to scan electrode SC129, which is the first scan electrode of scan electrode SC129 through scan electrode SC192 included in partial display region Ar3. Next, a scan pulse of a pulse width of time T2 is applied to scan electrode SC130. Subsequently, scan pulses of a pulse width of time T2 are applied to scan electrodes 22 in the arranging sequence of scan electrodes 22 on panel 10, for example, in the sequence of scan electrode SC131, scan electrode SC132, scan electrode SC133, . . . , and scan electrode SC192.

Next, an address operation is performed in partial display region Ar1 of the third-highest partial light-emitting ratio. In partial display region Ar1, a scan pulse is firstly applied to scan electrode SC1, which is the first scan electrode of scan electrode SC1 through scan electrode SC64 included in partial display region Ar1. The pulse width of the scan pulse is time T1. Next, a scan pulse of a pulse width of time T2 is applied to scan electrode SC2. Subsequently, scan pulses are applied to scan electrodes 22 in the arranging sequence of scan electrodes 22 on panel 10, for example, in the sequence of scan electrode SC3, scan electrode SC4, scan electrode SC5, . . . , and scan electrode SC64. The pulse width of these scan pulses is also time T2.

Thus, in the present exemplary embodiment, in each of the partial display regions, the ratio of the number of discharge cells to be lit to the total number of discharge cells is detected as a partial light-emitting ratio, and the address operation is performed firstly in the partial display region of the highest partial light-emitting ratio. In each partial display region, scan pulses are applied to scan electrodes 22 in the arranging sequence of scan electrodes 22 on panel 10. In other words, the sequential address operation is performed in each partial display region.

In the present exemplary embodiment, when the sequential address operation is performed, a scan pulse of a pulse width of time T1 is applied to scan electrode 22 to which the scan pulse is to be firstly applied in the address period. In the example of FIG. 10, a scan pulse of a pulse width of time T1 is applied to scan electrode SC65.

When scan electrode 22 to which a scan pulse is to be finally applied in one partial display region is not adjacent to scan electrode 22 to which a scan pulse is to be firstly applied in a partial display region where the address operation is performed next to the one partial display region, a scan pulse of a pulse width of time T1 is applied to scan electrode 22 where the address operation is to be firstly performed in the partial display region. In the example of FIG. 10, scan electrode SC192 to which a scan pulse is finally applied in partial display region Ar3 is not adjacent to scan electrode SC1 to which a scan pulse is firstly applied in partial display region Ar1 where the address operation is performed next. Therefore, a scan pulse of a pulse width of time T1 is applied to scan electrode SC1.

Scan pulses of a pulse width of time T2 are applied to the other scan electrodes 22.

Therefore, when scan electrode 22 where the address operation is performed finally in one partial display region is adjacent to first scan electrode 22 in the partial display region where the address operation is performed next, a scan pulse of a pulse width of time T2 is applied to scan electrode 22 where the address operation is firstly performed in the latter partial display region. In the example of FIG. 10, scan electrode SC128 to which a scan pulse is finally applied in partial display region Ar2 is adjacent to scan electrode SC129 to which a scan pulse is firstly applied in partial display region Ar3 where the address operation is performed next. Therefore, a scan pulse of a pulse width of time T2 is applied to scan electrode SC129.

In the present exemplary embodiment, time T1 is set at 1.15 μsec, and time T2 is set at 1.05 μsec. In other words, time T1 is set at a time longer than time T2 by 0.1 μsec. Thus, the reason why the pulse width of the scan pulse is controlled when the sequential address operation is performed is as follows. The specific numerical values of time T1 and time T2 are simply one example in the present exemplary embodiment. Time T1 and time T2 of the present invention are not limited to these numerical values.

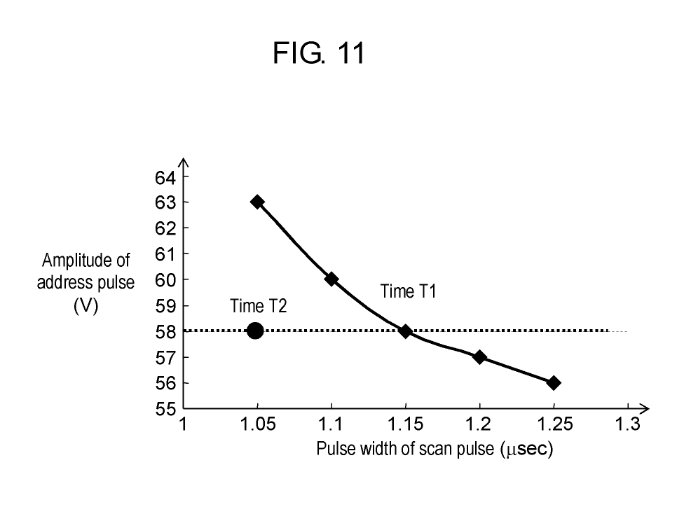

FIG. 11 is a characteristic diagram showing the relationship between the pulse width of the scan pulse and the amplitude of the address pulse required for causing stable address discharge. In FIG. 11, the horizontal axis shows the pulse width of the scan pulses applied to scan electrodes 22, and the vertical axis shows the amplitude of the address pulse required for causing stable address discharge. The solid line shows the characteristic in the discharge cell formed on scan electrode 22 where the address operation is firstly performed in the address period when the sequential address operation is performed. The black circle shows the characteristic in the discharge cell formed on the other scan electrodes 22.

The inventor has recognized the following phenomenon: when the sequential address operation is performed, in the discharge cell formed on scan electrode 22 where the address operation is firstly performed in the address period, the amplitude of the address pulse required for causing stable address discharge is larger than that in the discharge cells formed on the other scan electrodes 22. As shown in FIG. 11, when the pulse width of the scan pulse is set at 1.05 μsec, the amplitude of the address pulse required for causing stable address discharge is about 63 (V) in the discharge cell formed on scan electrode 22 where the address operation is firstly performed in the address period, but is about 58 (V) in the discharge cells formed on the other scan electrodes 22. The difference is about 5 (V).

The inventor has recognized the following phenomenon: the amplitude of the address pulse required for causing stable address discharge is also large even when a discharge cell formed on scan electrode 22 where the address operation is firstly performed in one partial display region is not adjacent to a discharge cell where the address operation is performed immediately before it. In the example of FIG. 10, this discharge cell is the discharge cell formed on scan electrode SC65 where the address operation is firstly performed in partial display region Ar2, or the discharge cell formed on scan electrode SC1 where the address operation is firstly performed in partial display region Ar1.

This is considered to be for the following reason. When address discharge occurs in one discharge cell (e.g. discharge cell A), a part of the priming particles (charged particles for assisting occurrence of discharge) generated by the address discharge leaks to discharge cell B adjacent to discharge cell A and address discharge is apt to occur in discharge cell B. Therefore, when address discharge occurs in discharge cell A in the sequential address operation, in discharge cell B that is adjacent to discharge cell A and where the address operation is performed next, address discharge is relatively easily caused by the priming particles occurring in discharge cell A. In the example of FIG. 10, discharge cell B is a discharge cell formed on scan electrode SC66 where the address operation is secondly performed in partial display region Art, or a discharge cell formed on scan electrode SC129 where the address operation is firstly performed in partial display region Ar3.

While, in the discharge cell formed on scan electrode 22 where the address operation is firstly performed in the address period, address discharge does not occur in its adjacent discharge cell. Therefore, the priming particles (which leak from the adjacent discharge cell having undergone address discharge) do not exist. Therefore, address discharge is considered to hardly occur in such a discharge cell comparing with discharge cell B. Similarly, address discharge hardly occurs in the discharge cell that is not adjacent to the partial display region where the address operation is performed immediately before it. In other words, address discharge hardly occurs in the discharge cell that is formed on scan electrode 22 where the address operation is firstly performed in the partial display region and is not adjacent to the discharge cell where the address operation is performed immediately before it. In the example of FIG. 10, this discharge cell corresponds to the discharge cell formed on scan electrode SC1.

In such a discharge cell lacking in priming particles, the period (discharge delay time) after the voltage is applied to the discharge cell until discharge occurs actually is longer than that in a discharge cell having sufficient priming particles. This discharge delay time is improved by increasing the voltage applied to the discharge cell. This is considered to be the reason why the amplitude of the address pulse required for causing stable address discharge is larger in the above-mentioned discharge cell than in the other discharge cells

This trend becomes more remarkable in the panel having enhanced definition. This is because a discharge cell is more easily affected by its adjacent discharge cell when the discharge cells are fined by enhancement in definition.

The reason why discharge becomes unstable when the discharge delay time increases is mainly considered as follows: when the discharge delay time increases, the time until discharge occurs exceeds the pulse width (time when voltage is applied to the discharge cell), and the applied voltage of the discharge cell decreases before discharge occurs. Therefore, by increasing the pulse width of the scan pulse in response to the discharge delay time, stable address discharge can be caused without increasing the amplitude of the address pulse. This is clear from the fact that, as the pulse width of the scan pulse increases, the amplitude of the address pulse required for causing stable address discharge decreases, as shown by the solid line in FIG. 11.

Thus, in the present exemplary embodiment, when a sequential address operation is performed, a scan pulse of a pulse width of time T1 is applied to scan electrode 22 to which a scan pulse is to be firstly applied in the partial display region where the address operation is firstly performed in the address period. Also when scan electrode 22 to which a scan pulse is finally applied in one partial display region is not adjacent to scan electrode 22 to which a scan pulse is firstly applied in a partial display region where the address operation is performed next to the one partial display region, a scan pulse of a pulse width of time T1 is applied to scan electrode 22 to which a scan pulse is to be firstly applied. Scan pulses of a pulse width of time T2 shorter than time T1 are applied to the other scan electrodes 22.

Thus, as shown in the present exemplary embodiment, when the address operation is performed firstly in the partial display region of the highest partial light-emitting ratio and the sequential address operation is performed in each partial display region, stable address discharge can be caused without increasing the amplitude of the address pulse.

In the present exemplary embodiment, time T1 is longer than time T2 by 0.1 μsec. However, preferably, time T1 is longer than time T2 by 0.1 μsec or longer. As shown in FIG. 11, this is based on the following measurement result: when time T1 is set at 1.15 μsec, which is 0.1 μsec longer than time T2, the amplitude of the address pulse required for causing stable address discharge is substantially the same between the characteristic shown by the black circle (characteristic shown by the broken line) and that shown by the solid line. However, time T1 and time T2 of the present invention are not limited to these numerical values. Preferably, each time is set optimally in response to the characteristics of panel 10 and the specification of the plasma display apparatus. When the priming particles are significantly insufficient and the discharge delay time of the address discharge increases, preferably, time T1 and time T2 are appropriately set in response to the magnitude of the discharge delay time, for example time T1 is set at 1.35 μsec.

Next, the driver circuits of the plasma display apparatus of the present exemplary embodiment are described.

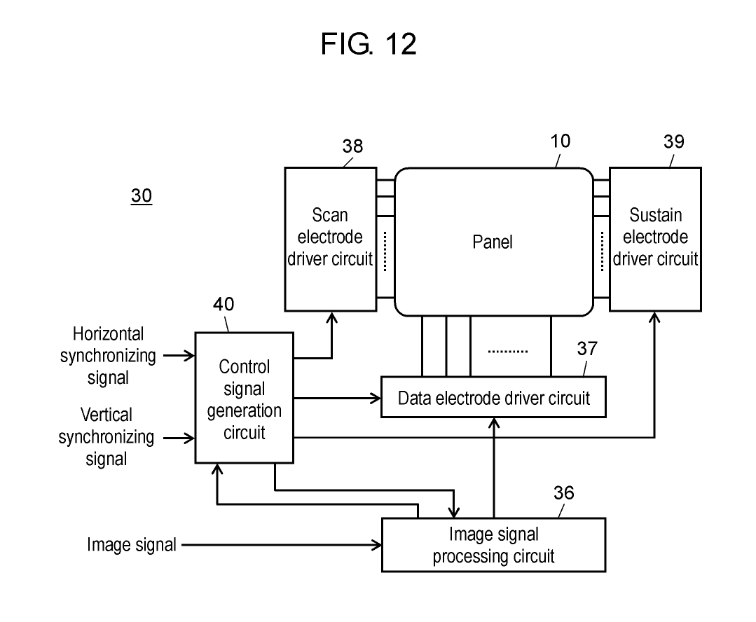

FIG. 12 is a circuit block diagram of plasma display apparatus 30 in accordance with the exemplary embodiment of the present invention. Plasma display apparatus 30 includes panel 10 and a driver circuit. The driver circuit includes the following elements:
image signal processing circuit 36;
data electrode driver circuit 37;
scan electrode driver circuit 38;
sustain electrode driver circuit 39;
control signal generation circuit 40; and
a power supply circuit (not shown) for supplying power required for each circuit block.

Image signal processing circuit 36 assigns a gradation value to each discharge cell based on an input image signal and the number of pixels displayable on panel 10. Then, image signal processing circuit 36 converts the gradation value into image data in which light emission and no light emission in each subfield are made to correspond to digital signals, “1” and “0”.

For example, when input image signal sig includes an R signal, a G signal, and a B signal, image signal processing circuit 36 assigns each gradation value of R, G, and B to each discharge cell based on the R signal, the G signal, and the B signal. When input image signal sig includes a luminance signal (Y signal) and a chroma signal (C signal, R-Y signal and B-Y signal, or u signal and v signal), image signal processing circuit 36 calculates the R signal, the G signal, and the B signal based on the luminance signal and chroma signal, and then assigns each gradation value (gradation value represented in one field) of R, G, and B to each discharge cell. Image signal processing circuit 36 converts each gradation value of R, G, and B assigned to each discharge cell into image data that indicates light emission or no light emission in each subfield.

Control signal generation circuit 40 generates various timing signals for controlling operations of respective circuit blocks based on a horizontal synchronizing signal and a vertical synchronizing signal. Control signal generation circuit 40 supplies the generated timing signals to respective circuit blocks.

Control signal generation circuit 40 divides the image display region of panel 10 into a plurality of partial display regions, and detects the ratio of the number of discharge cells to be lit to the total number of discharge cells as “partial light-emitting ratio” in each partial display region in each subfield. Based on the detected partial light-emitting ratio, control signal generation circuit 40 determines the sequence of the partial display regions for performing the address operation.

Control signal generation circuit 40 calculates a power consumption (estimated value) when the sequential address operation is performed and a power consumption (estimated value) when the overshoot address operation is performed. Control signal generation circuit 40 determines whether to perform the sequential address operation or the overshoot address operation based on the calculation result. In addition, control signal generation circuit 40 determines the pulse width of the scan pulse.

In the present exemplary embodiment, “partial light-emitting ratio” is calculated while 64 scan electrodes 22 consecutively arranged on panel 10 are set as one partial display region. However, the present invention is not limited to this configuration. Preferably, the partial display regions are set optimally in response to the characteristics of panel 10 and the specification of plasma display apparatus 30.

In the present exemplary embodiment, the partial light-emitting ratio is calculated using normalizing calculation for percentage notation (% notation). However, normalizing calculation is not always required, the calculated number of discharge cells to be lit may be used as the partial light-emitting ratio.

Data electrode driver circuit 37 converts data in each subfield constituting the image data into an address pulse corresponding to each of data electrode D1 through data electrode Dm. Data electrode driver circuit 37 applies the address pulse to each of data electrode D1 through data electrode Dm based on the control signal supplied from control signal generation circuit 40. Data electrode driver circuit 37 generates an address pulse at a pulse width corresponding to the pulse width of the scan pulse.

Scan electrode driver circuit 38 has an initializing waveform generation section, a sustain pulse generation section, and a scan pulse generation section (not shown in FIG. 12). The initializing waveform generation section generates an initializing waveform to be applied to scan electrode SC1 through scan electrode SCn in the initializing period. The sustain pulse generation section generates a sustain pulse to be applied to scan electrode SC1 through scan electrode SCn in the sustain period. The scan pulse generation section has a plurality of scan electrode driver ICs (hereinafter referred to as “scan ICs”), and generates scan pulses to be applied to scan electrode SC1 through scan electrode SCn in the address period. Scan electrode driver circuit 38 drives each of scan electrode SC1 through scan electrode SCn based on the control signal supplied from control signal generation circuit 40. In other words, scan electrode driver circuit 38 generates scan pulses at the pulse width responsive to the control signal, and applies the scan pulses to scan electrode SC1 through scan electrode SCn in the sequence responsive to the control signal.

Sustain electrode driver circuit 39 has a sustain pulse generation section and a circuit (not shown) for generating voltage Ve1 and voltage Ve2. Sustain electrode driver circuit 39 drives sustain electrode SU1 through sustain electrode SUn based on the control signal supplied from control signal generation circuit 40.

Next, the details and operation of scan electrode driver circuit 38 are described. In the following description, an operation of conducting a switching element is denoted as “ON”, an operation of blocking it is denoted as “OFF”, a signal for setting a switching element at ON is denoted as “Hi”, and a signal for setting it at OFF is denoted as “Lo”.

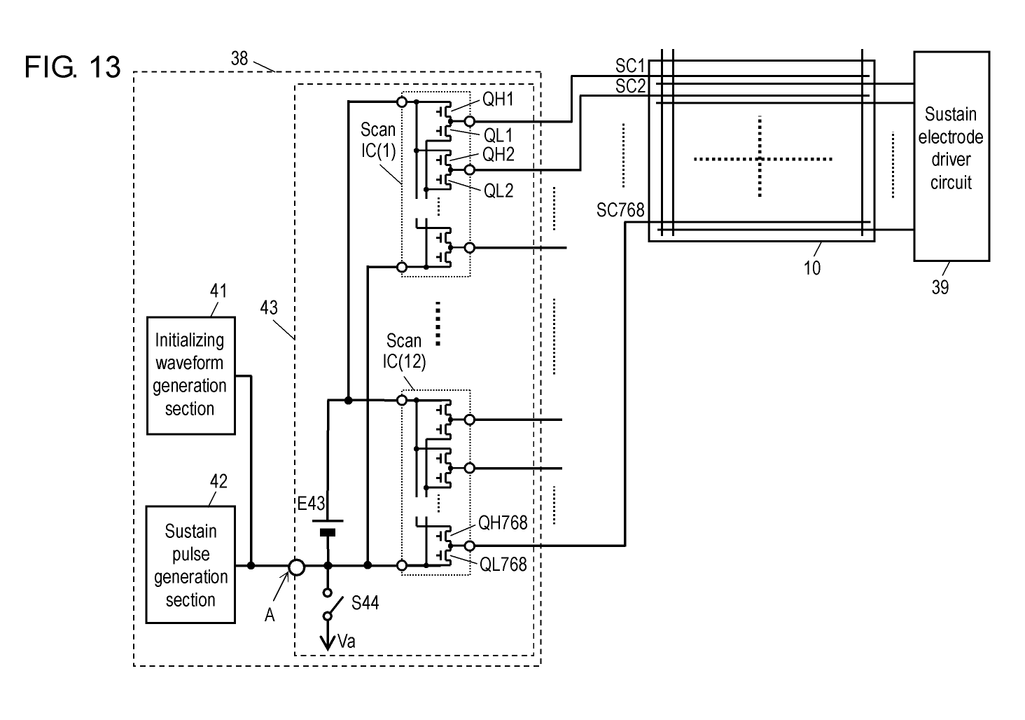

FIG. 13 is a circuit diagram showing a configuration of scan electrode driver circuit 38 of plasma display apparatus 30 in accordance with the exemplary embodiment of the present invention. Scan electrode driver circuit 38 has initializing waveform generation section 41, sustain pulse generation section 42 on the scan electrode 22 side, and scan pulse generation section 43. Each output terminal of scan pulse generation section 43 is connected to each of scan electrode SC1 through scan electrode SCn of panel 10. A scan pulse can be thus applied to each of scan electrodes 22 in the address period.

Scan pulse generation section 43 has the following elements:
switch S44 for connecting reference potential A of scan pulse generation section 43 to negative voltage Va;
power supply E43 for adding voltage Vscn to reference potential A;
switching element QH1 through switching element QHn for applying the voltage (voltage on the high voltage side of power supply E43) obtained by adding voltage Vscn to reference potential A to each of scan electrode SC1 through scan electrode SCn; and
switching element QL1 through switching element QLn for applying reference potential A (voltage on the low voltage side of power supply E43) to each of scan electrode SC1 through scan electrode SCn.
   Reference potential A is voltage to be input to scan pulse generation section 43 as shown in FIG. 13. In FIG. 13, n is assumed to be 768.

Switching element QH1 through switching element QHn and switching element QL1 through switching element QLn are classified into groups each of which has a plurality of outputs, and the groups are integrated as ICs. These ICs are scan ICs. By setting switching element QHi at OFF and switching element QLi at ON based on the control signal supplied from control signal generation circuit 40, a scan pulse of negative voltage Va is applied to scan electrode SCi via switching element QLi. In other words, scan electrode driver circuit 38 has a plurality of scan ICs for generating scan pulses to be applied to scan electrode SC1 through scan electrode SCn.

In the present exemplary embodiment, switching elements corresponding to 64 outputs are integrated as one monolithic IC. Scan pulse generation section 43 is configured using 12 scan ICs (hereinafter referred to as “scan IC(1), scan IC(2), . . . , and scan IC(12)”), and drives n(=768) scan electrode SC1 through scan electrode SCn. Scan IC(1) drives scan electrode SC1 through scan electrode SC64 belonging to partial display region Ar1, scan IC(2) drives scan electrode SC65 through scan electrode SC128 belonging to partial display region Ar2, scan IC(3) drives scan electrode SC129 through scan electrode SC192 belonging to partial display region Ar3, subsequently, similarly each scan IC drives 64 scan electrodes 22 belonging to each partial display region, and final scan IC(12) drives scan electrode SC705 through scan electrode SC768 belonging to partial display region Ar12. Thus, by integrating many switching element QH1 through switching element QHn and switching element QL1 through switching element QLn, the circuits can be compacted and the area (mounting area) for mounting the circuits on a printed circuit board can be decreased. The cost required for manufacturing plasma display apparatus 30 can be also reduced.

Initializing waveform generation section 41 increases or decreases reference potential A of scan pulse generation section 43 in a ramp shape in the initializing period based on the control signal supplied from control signal generation circuit 40, and generates the initializing waveforms shown in FIG. 3.

At this time, by setting switching element QH1 through switching element QHn of scan pulse generation section 43 at OFF and switching element QL1 through switching element QLn at ON, initializing waveforms are applied to scan electrode SC1 through scan electrode SCn via switching element QL1 through switching element QLn, respectively. By setting switching element QH1 through switching element QHn at ON and switching element QL1 through switching element QLn at OFF, waveforms obtained by adding voltage Vscn of power supply E43 to the initializing waveforms generated by initializing waveform generation section 41 are applied to scan electrode SC1 through scan electrode SCn via switching element QH1 through switching element QHn, respectively.

Sustain pulse generation circuit 42 includes a power recovery circuit and a clamping circuit (not shown). The power recovery circuit has a capacitor for power recovery and an inductor for resonance, and raises and falls a sustain pulse by LC resonating the inter-electrode capacity of panel 10 and the inductor. The clamping circuit clamps scan electrode SC1 through scan electrode SCn on voltage Vsus or ground potential (0 (V)). Sustain pulse generation circuit 42 generates sustain pulses by setting reference potential A to be input to scan pulse generation section 43 at voltage Vsus or ground potential (0 (V)) while switching and operating the power recovery circuit and clamping circuit based on the control signal supplied from control signal generation circuit 40.

At this time, by setting switching element QH1 through switching element QHn of scan pulse generation section 43 at OFF and switching element QL1 through switching element QLn at ON, the sustain pulses are applied to scan electrode SC1 through scan electrode SCn via switching element QL1 through switching element QLn.

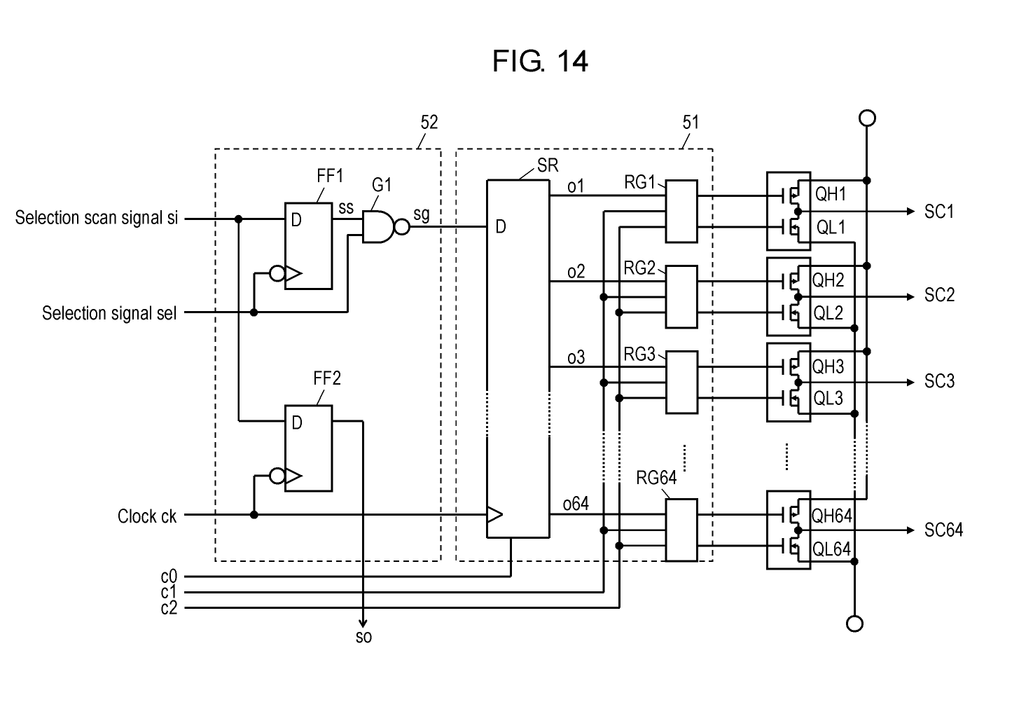

FIG. 14 is a circuit block diagram showing the details of a scan IC of plasma display apparatus 30 in accordance with the exemplary embodiment of the present invention. FIG. 14 shows scan IC(1) as one example of the scan ICs, and the operation of scan IC(1) is described as an example. However, the other scan IC(2) through scan IC(12) have the same configuration and perform the same operation.

Scan IC(1) has switching element QH1 through switching element QH64 and switching element QL1 through switching element QL64 for outputting scan pulse voltage as discussed above. Then, 64 output terminals of scan IC(1) are connected to scan electrode SC1 through scan electrode SC64, and drive scan electrode SC1 through scan electrode SC64, respectively. In addition, scan IC(1) includes switching element control section 51 for controlling switching element QH1 through switching element QH64 and switching element QL1 through switching element QL64, and scan IC selecting section 52 for determining the sequence of the address operation of the scan IC.

Switching element control section 51 has output control section RG1 through control section RG64, and shift resistor SR. Shift resistor SR has a data input terminal, a clock input terminal, a control signal input terminal, and 64 output terminals. Shift resistor SR outputs 64 signal o1 through signal o64 for generating scan pulses to output control section RG1 through control section RG64, respectively.

Signal sg as the output signal of NAND gate G1 (described later) is input to the data input terminal of shift resistor SR, clock ck as a synchronizing signal (clock signal) is input to the clock input terminal, and control signal c0 is input to the control signal input terminal.

Control signal c0 is a control signal used for selecting one of the sequential address operation and overshoot address operation. Signal sg is a single pulse signal that generates one negative-polarity pulse of a pulse width (for example, the pulse width corresponding to one cycle of clock ck) having one rising of clock ck. This pulse width means the time from the falling to the rising of control signal c0.

When control signal c0 is at low level (hereinafter referred to as “Lo”), shift resistor SR sequentially shifts signal sg by one cycle (one clock) of clock ck whenever the rising of clock ck is input, and outputs signal sg as signal o1 through signal o64. In other words, the single pulse of signal sg sequentially shifts in the sequence of signal o1, signal o2, signal o3, . . . , and signal o64. In other words, signal o1, signal o2, signal o3, . . . , and signal o64 are obtained by sequentially shifting the single pulse of signal sg. When control signal c0 is at “Lo”, shift resistor SR outputs the single pulse of signal sg to output control section RG1 through output control section RG64 in the sequence of output control section RG1, output control section RG2, output control section RG3, . . . , and output control section RG64.

When control signal c0 is at high level (hereinafter referred to as “Hi”), shift resistor SR outputs the single pulse of signal sg firstly to odd-numbered output control sections RG, of output control section RG1 through output control section RG64, and secondly to even-numbered output control sections RG. In other words, shift resistor SR outputs the single pulse of signal sg to output control section RG1, output control section RG3, output control section RG5, . . . , and output control section RG63, output control section RG2, output control section RG4, output control section RG6, . . . , and output control section RG64 in that order.

Output control section RG1 receives control signal c1, control signal c2, and output signal o1 of shift resistor SR, and controls switching element QH1 and switching element QL1. Output control section RG2 receives control signal c1, control signal c2, and output signal o2 of shift resistor SR, and controls switching element QH2 and switching element QL2. Subsequently, output control section RG3 through output control section RG64 perform similar operations. The operations of output control sections RG are described hereinafter.

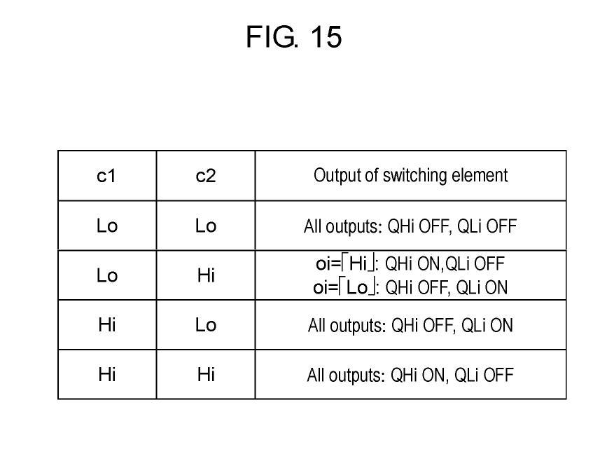

FIG. 15 is a diagram showing operations of output control sections RG, switching elements QH, and switching elements QL of the scan ICs of plasma display apparatus 30 in accordance with the exemplary embodiment of the present invention. In the present exemplary embodiment, output control sections RG control switching elements QH and switching elements QL in response to control signal c1 and control signal c2 as follows. Output control section RG1 is hereinafter described as an example, but the other output control sections RG perform similar operations. In FIG. 15, switching element QHi and switching element QLi are used.

When both control signal c1 and control signal c2 are at “Lo”, output control section RG1 sets both switching element QH1 and switching element QL1 at “OFF”, and puts the output terminal connected to scan electrode SC1 into a high-impedance state.

When control signal c1 is at “Lo” and control signal c2 is at “Hi”, output control section RG1 controls switching element QH1 and switching element QL1 based on output signal o1 of shift resistor SR. In the present exemplary embodiment, when output signal o1 of shift resistor SR is at “Hi”, switching element QH1 is set at ON and switching element QL1 is set at OFF. When output signal o1 of shift resistor SR is at “Lo”, switching element QH1 is set at OFF and switching element QL1 is set at ON.

When control signal c1 is at “Hi” and control signal c2 is at “Lo”, output control section RG1 sets switching element QH1 at OFF and sets switching element QL1 at ON.

When both control signal c1 and control signal c2 are at “Hi”, output control section RG1 sets switching element QH1 at “ON” and sets switching element QL1 at “OFF”

As shown in FIG. 14, scan IC selecting section 52 includes flip flop FF1, flip flop FF2, and NAND gate G1. Flip flop FF1 is a normal flip flop having a data input terminal, a clock input terminal, and an output terminal. Scan IC selecting section 52 captures selection scan signal s1 input to the data input terminal at a falling timing of selection signal sel input to the clock input terminal, and outputs it as signal ss to NAND gate G1.

NAND gate G1 performs a logical product operation of output signal ss of flip flop FF1 and selection signal sel, logically inverts the operation result, and outputs the inversion result as signal sg. In other words, signal sg is “0” only when both output signal ss of flip flop FF1 and selection signal sel are “1”. Otherwise, signal sg is “1”. As discussed above, signal sg is input to the data input terminal of shift resistor SR.

Flip flop FF2 has a configuration similar to that of flip flop FF1, the data input terminal thereof receives selection scan signal si, and the clock input terminal receives clock ck. Flip flop FF2 outputs delay signal so obtained by delaying selection scan signal si by one clock.

Control signal c0, control signal c1, control signal c2, selection signal sel, selection scan signal si, and clock ck are included in control signals supplied from control signal generation circuit 40.

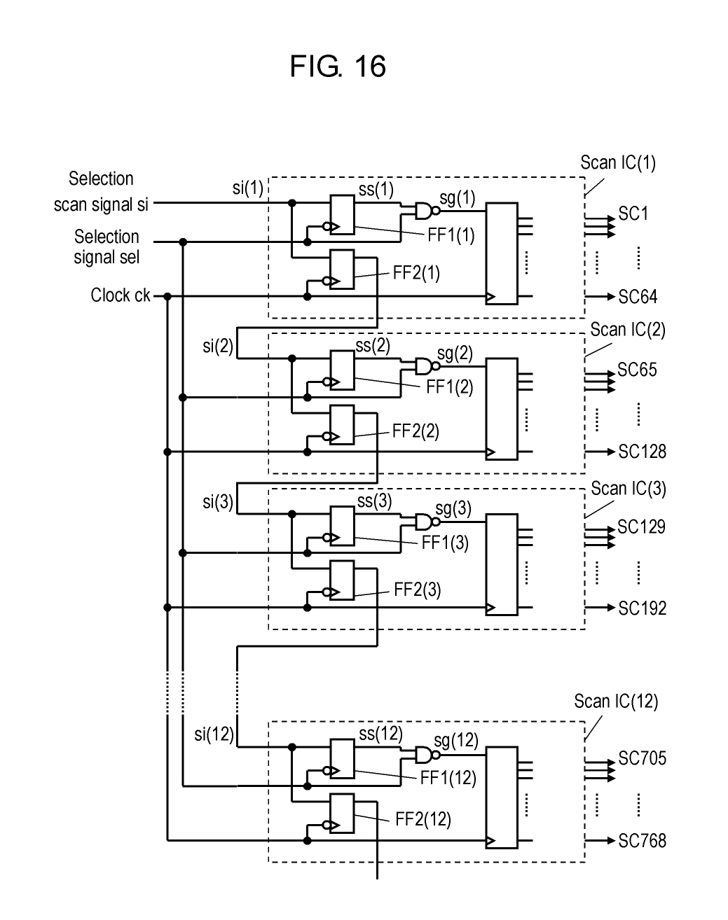

FIG. 16 is a diagram showing the connection of scan IC(1) through scan IC(12) of plasma display apparatus 30 in accordance with the exemplary embodiment of the present invention.

Each of 12 scan ICs (scan IC(1) through scan IC(12)) commonly receives control signal c0, control signal c1, control signal c2, selection signal sel, and clock ck (control signal c0, control signal c1, and control signal c2 are not shown in FIG. 16). However, selection scan signal s1 is input to only first scan IC, namely scan IC(1).

Scan IC(1) generates delay signal so(1) obtained by delaying selection scan signal si by one clock cycle of clock ck, and inputs delay signal so(1) as selection scan signal si(2) to the second scan IC, namely scan IC(2). Next, scan IC(2) generates delay signal so(2) obtained by delaying selection scan signal si(2) by one clock cycle of clock ck, and inputs delay signal so(2) as selection scan signal si(3) to third scan IC(3). Hereinafter, similarly, each scan IC outputs delay signal so, and inputs it as selection scan signal si to the subsequent scan IC. Finally, delay signal so(11) output from scan IC(11) is input as selection scan signal si(12) into scan IC(12). Thus, 12 scan ICs (scan IC(1) through scan IC(12)) are cascade-interconnected so that, after scan IC(1), selection scan signal si is sequentially input to scan IC(2) through scan IC(12) while selection scan signal si is delayed sequentially by one clock cycle of clock ck.

The scan ICs are interconnected so that control signal c0, control signal c1, control signal c2, selection signal sel, and clock ck are input in parallel into each scan IC and, after scan IC(1), selection scan signal si is sequentially input to scan IC(2) through scan IC(12). By inputting each signal to each scan IC, one scan IC is selected optionally from 12 scan ICs, and the address operation of the partial display region connected to the one scan IC can be performed.

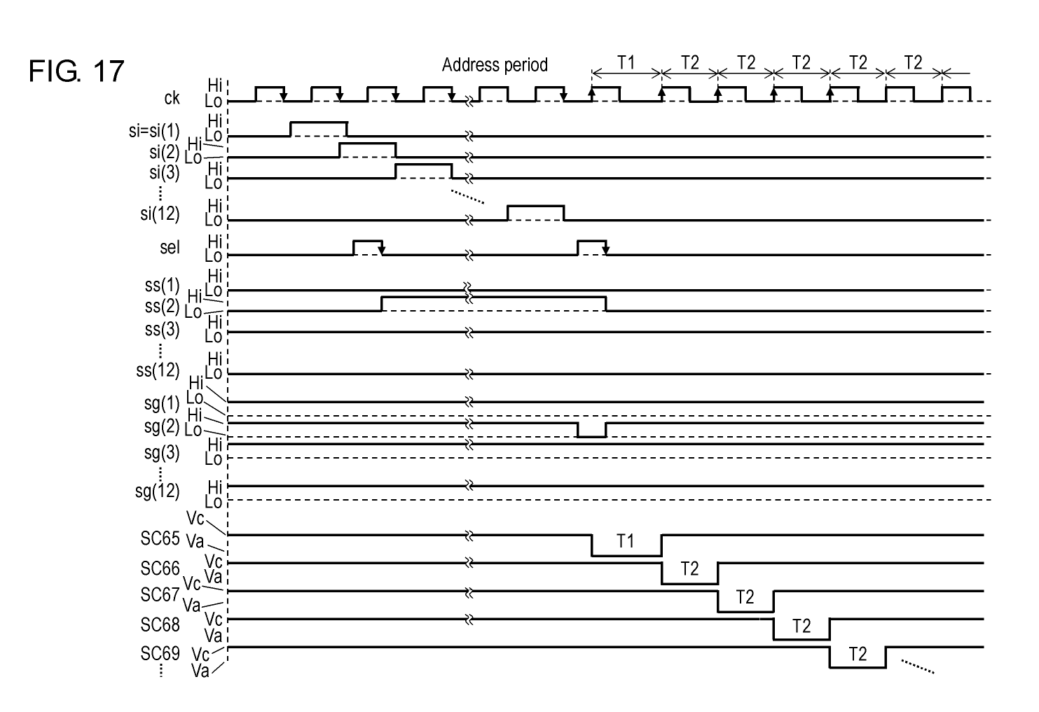

FIG. 17 is a timing chart for illustrating the operation of the scan ICs of plasma display apparatus 30 in accordance with the exemplary embodiment of the present invention. FIG. 17 shows the timing chart as an example when second scan IC, namely scan IC(2), is selected.

Selection scan signal si having a pulse width of one clock cycle of clock ck is input from control signal generation circuit 40 into scan IC(1). The pulse width means the time from the rising to the falling of selection scan signal si.

Selection scan signal si is input as selection scan signal si(1) into the data input terminal of flip flop FF2(1) in scan IC(1). Flip flop FF2(1) delays selection scan signal si(1) by one clock cycle of clock ck, and outputs it. The output signal is input as selection scan signal si(2) into scan IC(2). Subsequently, selection scan signal si(N) (N is 2 through 11) is delayed by one clock cycle of clock ck by each scan IC (scan IC(2) through scan IC(11)), and is input as selection scan signal si(N+1) into the subsequent scan IC (scan IC(3) through scan IC(12)).

Which scan IC is selected from a plurality of scan ICs is determined dependently on the falling timing of selection signal sel output from control signal generation circuit 40. In other words, pulse-like selection signal sel is input to each scan IC with the timing when selection scan signal si is input to scan IC intended to be selected.

As discussed above, with the falling timing of selection signal sel, flip flop FF1 of the scan IC captures a signal to be input to the data input terminal thereof, and outputs it as output signal ss. In the example shown in FIG. 17, when selection scan signal si(2) is at “Hi”, a pulse of selection signal sel is generated. Therefore, only output signal ss(2) of flip flop FF1(2) of scan IC(2) is at “Hi”, and the other output signals, namely output signal ss(1) and output signal ss(3) through output signal ss(12), are at “Lo”.

Then, selection scan signal si(12) is input to 12th scan IC(12), signal so(12) obtained by delaying it by one clock cycle of clock ck is output from flip flop FF2(12), and then pulse-like selection signal sel including one rising of clock ck is input to each scan IC.

Thus, output signal sg(2) of NAND gate G1(2) of scan IC(2) is at “Lo” for the same period as the pulse width of selection signal sel. In other words, a negative-polarity single pulse is generated. Output signals sg (output signal sg(1), and output signal sg(3) through output signal sg(12)) of NAND gates 01 of the scan ICs other than scan IC(2) are kept at “Hi”.

All of output signal ss(1) through output signal ss(12) of flip flop FF1(1) through flip flop FF1(12) of scan IC(1) through scan IC(12) come into “Lo” with the falling timing of selection signal sel.

Thus, a negative-polarity single pulse, namely signal sg(2) which is at “Lo” for the period including one rising of clock ck, is input to only shift resistor

SR(2) of second scan IC(2). Then, whenever clock ck is input, shift resistor SR(2) sequentially shifts the single pulse of signal sg(2).

Control signal c0 is at “Lo” (not shown), so that scan pulses are applied sequentially to scan electrode SC65, scan electrode SC66, . . . , and scan electrode SC128 in that order.

When control signal c0 is at “Hi” (not shown), scan pulses are applied sequentially to scan electrode SC65, scan electrode SC67, . . . , scan electrode SC127, scan electrode SC66, scan electrode SC68, . . . , and scan electrode SC128 in that order.

When scan electrode SC65 is scan electrode 22 where an address operation is firstly performed in the address period, control signal generation circuit 40 sets, as time T1, only the clock cycle of clock ck corresponding to the scan pulse to be applied to scan electrode SC65. Then, when the other scan pulses are generated, control signal generation circuit 40 sets the clock cycle of clock ck as time T2. Thus, a scan pulse of a pulse width of time T1 is applied to scan electrode SC65, and scan pulses of a pulse width of time T2 are applied to scan electrode SC66 through scan electrode SC128.

In the present exemplary embodiment, a scan pulse of a desired pulse width is obtained by changing the clock cycle of clock ck as discussed above.

It is determined by control signal generation circuit 40 whether the pulse width of the scan pulse that is applied to first scan electrode 22 in each partial display region is set at time T1 or time T2.

In the present exemplary embodiment, only when the sequential address operation is performed, the pulse width of the scan pulse is switched between time T1 and time T2 in response to the sequence of the address operation. When the overshoot address operation is performed, address discharge does not occur continuously in adjacent discharge cells. Therefore, preferably, the pulse width is set optimally so that stable address discharge can be caused even in this case.

“Adjacent discharge cells” having been described in the present exemplary embodiment mean the discharge cells adjacent in the extending direction of data electrodes 32.

In the present exemplary embodiment, the specific subfield may be a subfield where the sequential address operation is always performed. For example, the first subfield shown in FIG. 3 is a subfield where an all-cell initializing operation is performed, so that this subfield may be a subfield where the sequential address operation is always performed.

The polarity of each control signal shown in the present exemplary embodiment is not limited to the above-mentioned polarity. The polarity may be inverse to the above-mentioned polarity as long as an operation similar to that described in the present exemplary embodiment is performed.

Each circuit block shown in the exemplary embodiment of the present invention may be configured as an electric circuit for performing each operation shown in the embodiment, or may be configured using a microcomputer or the like programmed so as to perform a similar operation.

In the present exemplary embodiment, an example where one pixel is formed of discharge cells of three colors R, G, and B has been described. However, also in a panel where one pixel is formed of discharge cells of four or more colors, the configuration shown in the present embodiment can be applied and a similar effect can be produced.

The above-mentioned driver circuits are one example, and the configurations of them are not limited to the above-mentioned configurations.

Each specific numerical value shown in the present exemplary embodiment is set based on the characteristics of panel 10 having a screen size of 50 inches and having 768 display electrode pairs 24, and is simply one example in the embodiment. The present invention is not limited to these numerical values. Numerical values are preferably set optimally in response to the characteristics of the panel or the specification of the plasma display apparatus. These numerical values can vary in a range allowing the above-mentioned effect. The number of subfields and the luminance weight of each subfield are not limited to the values shown in the exemplary embodiment of the present invention, but the subfield structure may be changed based on an image signal or the like.

### INDUSTRIAL APPLICABILITY

In the present invention, stable address discharge can be caused even in a panel where the definition is enhanced and the screen is enlarged. The present invention is useful as a driving method of the panel and a plasma display apparatus.

### REFERENCE MARKS IN THE DRAWINGS

10 panel
21 front substrate
22 scan electrode
23 sustain electrode
24 display electrode pair
25, 33 dielectric layer
26 protective layer
30 plasma display apparatus
31 rear substrate
32 data electrode
34 barrier rib
35 phosphor layer
36 image signal processing circuit
37 data electrode driver circuit
38 scan electrode driver circuit
39 sustain electrode driver circuit
40 control signal generation circuit
41 initializing waveform generation section
42 sustain pulse generation section
43 scan pulse generation circuit
51 switching element control section
52 scan IC selecting section

1. A driving method of a plasma display panel for driving the plasma display panel that has a plurality of discharge cells each of which includes a data electrode and a display electrode pair, the display electrode pair being formed of a scan electrode and a sustain electrode, one field including a plurality of subfields each of which has an address period and a sustain period, the driving method comprising:
dividing an image display region of the plasma display panel into a plurality of partial display regions each of which includes a plurality of consecutively arranged scan electrodes;
performing a sequential address operation in each partial display region in the address period, the sequential address operation sequentially applying scan pulses to the respective scan electrodes based on the arranging sequence of the scan electrodes on the plasma display panel; and
applying, to a scan electrode to which a scan pulse is to be firstly applied in the address period, a scan pulse of which pulse width is set longer than a pulse width of a scan pulse to be applied to the other scan electrodes.

2. The driving method of the plasma display panel of claim 1, the driving method comprising:
detecting, as a partial light-emitting ratio, a ratio of a number of discharge cells to be lit to a total number of discharge cells in each partial display region;
performing an address operation firstly in the partial display region of a highest partial light-emitting ratio; and
when a scan electrode to which a scan pulse is to be finally applied in one partial display region is not adjacent to a scan electrode to which a scan pulse is to be firstly applied in a partial display region where an address operation is performed next to the one partial display region, applying the scan pulse, of which pulse width is set longer, to the scan electrode to which a scan pulse is to be firstly applied.

3. A plasma display apparatus comprising:
a plasma display panel that has a plurality of discharge cells each of which includes a data electrode and a display electrode pair formed of a scan electrode and a sustain electrode; and
a driver circuit for driving the plasma display panel while one field includes a plurality of subfields having an address period and a sustain period,
wherein the driver circuit has a plurality of scan ICs for applying scan pulses to a plurality of consecutively arranged scan electrodes, and divides an image display region of the plasma display panel into a plurality of partial display regions, each of the partial display regions is formed of a plurality of scan electrodes connected to the scan ICs,
wherein, in each partial display region, the driver circuit detects, as a partial light-emitting ratio, a ratio of a number of discharge cells to be lit to a total number of discharge cells of each partial display region and performs an address operation firstly in the partial display region of a highest partial light-emitting ratio,
wherein the scan ICs perform a sequential address operation in each partial display region in the address period, sequential address operation sequentially applying scan pulses to the respective scan electrodes based on the arranging sequence of the scan electrodes on the plasma display panel, and
wherein the scan ICs apply, to a scan electrode to which a scan pulse is to be firstly applied in the address period, a scan pulse of which pulse width is set longer than a pulse width of a scan pulse to be applied to the other scan electrodes.
